(19) United States
(12) Patent Application Publication
(10) Pub. No.: US 2022/0411597 A1
(43) Pub. Date: Dec. 29, 2022

(54) COMPOSITION FOR FIBER-REINFORCED RESIN, FIBER-REINFORCED RESIN, MOLDED ARTICLE, METHOD FOR USING COMPOSITION FOR FIBER-REINFORCED RESIN, METHOD FOR REINFORCING FIBER-REINFORCED RESIN, AND METHOD FOR PRODUCING FIBER-REINFORCED RESIN

(71) Applicant: ARAKAWA CHEMICAL INDUSTRIES, LTD., OSAKA (JP)

(72) Inventors: Hisako OGAWA, Ibaraki (JP); Yukihiro NISHIOKA, Ibaraki (JP); Hiroki OCHIAI, Ibaraki (JP)

(73) Assignee: ARAKAWA CHEMICAL INDUSTRIES, LTD., OSAKA (JP)

(21) Appl. No.: 17/780,026

(22) PCT Filed: Nov. 19, 2020
(86) PCT No.: PCT/JP2020/043236

§ 371 Date: May 26, 2022

(30) Foreign Application Priority Data
Nov. 27, 2019 (JP) 2019-214658
Jun. 29, 2020 (JP) 2020-111265

(51) Int. Cl. C08J 5/24; C08J 5/04; C08J 5/10

(52) U.S. Cl. CPC C08J 5/247; C08J 5/243; C08J 5/244; C08J 5/249; C08J 5/043; C08J 5/10; C08J 2393/04; C08J 2395/00; C08J 2335/02; C08J 2325/18; C08J 2323/12; C08J 2325/06

(57) ABSTRACT

A composition for fiber-reinforced resin that provides a fiber-reinforced resin with sufficient mechanical strength. The composition for fiber-reinforced resin contains at least one resin (A) selected from the group consisting of rosin resins, petroleum resins, terpene resins, and hydrides of cyclic ketone-aldehyde resins, and the resin (A) has a softening point of 80° C. to 180° C.

### TECHNICAL FIELD

The present invention relates to a composition for fiber-reinforced resin, a fiber-reinforced resin, a molded article, a method for using a composition for fiber-reinforced resin, a method for reinforcing a fiber-reinforced resin, and a method for producing a fiber-reinforced resin.

### BACKGROUND ART

Due to their excellent mechanical characteristics such as mechanical strength, rigidity, and impact resistance, fiber-reinforced resins composed of a reinforcing fiber and a matrix resin are used in a wide range of areas, including sports equipment such as golf clubs, tennis rackets, and fishing rods; structural materials for aircraft and vehicles; and reinforcement of concrete structures. Because the market demands lighter, more rigid, and easier-to-handle fiber-reinforced resins, various efforts have been made to meet the demand from multiple points of view, such as changes of the fiber or matrix resin, or improvement of processing methods.

For reinforcing fibers, inorganic fibers such as glass fiber or carbon fiber are used. Recent years have seen increased applications of fiber-reinforced resins containing such inorganic fibers in areas such as electronics-related products, vehicle parts, and building materials. Such fiber-reinforced resins are produced, for example, by (i) preparing inorganic fiber in the form of woven fabric or nonwoven fabric by using chopped strands and then impregnating the inorganic fiber with a matrix resin, or a monomer used as a starting material for a matrix resin; or (ii) mixing inorganic fiber with a matrix resin or a starting material monomer for a matrix resin, and then molding and curing the mixture.

The matrix resin for use includes thermosetting resins (e.g., epoxy resins) and thermoplastic resins (e.g., polyolefin-based resins). Of these, polyolefin-based resins, such as polypropylene resins, are excellent, for example, in moldability, rigidity, heat resistance, chemical resistance, and electrical insulation, and are also inexpensive. Thus, polyolefin-based resins have a versatile and wide range of applications in films, fibers, and molded articles of various shapes.

In the production of a fiber-reinforced resin by combining a matrix resin with a reinforcing fiber, some matrix resins show low wettability to the reinforcing fiber. This may cause separation between the matrix resin and the reinforcing fiber, or form voids in the fiber-reinforced resin, decreasing the mechanical characteristics of the fiber-reinforced resin.

To address this problem, PTL 1 to 3 suggest a method of performing plasma treatment, ozone treatment, or corona treatment, optionally with chemical etching to add functional groups to the surface of carbon fiber, or a method of treating carbon fiber with a sizing agent, in order to strengthen chemical bonds of the carbon fiber. However, these methods increase manufacturing cost due to the increased number of processes and cause damage to the fiber itself, or are unable to sufficiently add wettability between the matrix resin and the fiber.

PTL 4 suggests a fiber-reinforced resin obtained by reacting a polypropylene resin with a rosin ester by melt-kneading to prepare a modified polyolefin resin, and combining the modified polyolefin resin with fibers. However, partial decomposition of the modified polyolefin resin during melt-kneading results in a fiber-reinforced resin with insufficient mechanical strength.

### CITATION LIST

### Patent Literature

PTL 1: JP2003-073932A
PTL 2: JP2003-128799A
PTL 3: JP2005-213679A
PTL 4: JP2016-74866A

### SUMMARY OF INVENTION

### Technical Problem

Given the circumstances above, the present invention was made, and an object of the invention is to provide a composition for fiber-reinforced resin that can provide a fiber-reinforced resin with sufficient mechanical strength.

### Solution to Problem

The present inventors conducted extensive research and found that the object is achieved by using a composition containing at least one resin selected from the group consisting of rosin resins, petroleum resins, terpene resins, and hydrides of cyclic ketone-aldehyde resins in fiber-reinforced resin. Specifically, the present invention relates to the following compositions for fiber-reinforced resin.

### Item 1.

A composition for fiber-reinforced resin (I) comprising a resin (A), wherein the resin (A) is at least one resin selected from the group consisting of rosin resins, petroleum resins, terpene resins, and hydrides of cyclic ketone-aldehyde resins, and the resin (A) has a softening point of 80° C. to 180° C.

### Item 2.

The composition for fiber-reinforced resin (I) according to Item 1, wherein the resin (A) is at least one member selected from the group consisting of α,β-unsaturated carboxylic-acid-modified rosins, rosin esters, rosin phenol resins, rosin diols, and petroleum resins.

### Item 3.

The composition for fiber-reinforced resin (I) according to Item 1 or 2, further comprising a surfactant (B), the composition for fiber-reinforced resin (I) being an emulsion (being in the form of an emulsion) comprising the resin (A) and the surfactant (B).

### Item 4.

A fiber-reinforced resin comprising
the composition for fiber-reinforced resin (I) of any one of Items 1 to 3,
a fiber (II), and
a matrix resin (III).

### Item 5.

The fiber-reinforced resin according to Item 4, wherein the fiber (II) is at least one fiber selected from the group consisting of carbon fiber and glass fiber.

### Item 6.

The fiber-reinforced resin according to Item 4 or 5, wherein the matrix resin (III) is a thermoplastic resin.

### Item 7.

A method for using the composition for fiber-reinforced resin (I) of any one of Items 1 to 3 in producing a fiber-reinforced resin containing a fiber (II), and a matrix resin (III).

### Item 8.

A method for reinforcing a fiber-reinforced resin containing a fiber (II), and a matrix resin (III) by using the composition for fiber-reinforced resin (I) of any one of Items 1 to 3.

### Item 9.

A method for producing the fiber-reinforced resin of any one of Items 4 to 6, the method comprising
(1) the step of mixing the fiber (II) with the matrix resin (III),
(2) the step of adhering the composition for fiber-reinforced resin (I) of any one of Items 1 to 3 to a product (mixture) obtained in step (1), and
(3) the step of heat-molding a product (adhered product) obtained in step (2).

### Item 10.

A method for producing the fiber-reinforced resin of any one of Items 4 to 6, the method comprising
(1) the step of adhering the composition for fiber-reinforced resin (I) of any one of Items 1 to 3 to the fiber (II), (2) the step of mixing a product (adhered product) obtained in step (1) with the matrix resin (III), and
(3) the step of heat-molding a product (mixture) obtained in step (2).

### Item 11.

A method for producing the fiber-reinforced resin of any one of Items 4 to 6, the method comprising
(1) the step of mixing the composition for fiber-reinforced resin (I) of any one of Items 1 to 3, the fiber (II), and the matrix resin (III), and
(2) the step of heat-molding a product (mixture) obtained in step (1).

### Item 12.

A molded article obtained by molding the fiber-reinforced resin of any one of Items 4 to 6.

### Advantageous Effects of Invention

The composition for fiber-reinforced resin according to the present invention provides a fiber-reinforced resin with sufficient mechanical strength, when combined with a fiber and a matrix resin. The composition for fiber-reinforced resin is used in various fiber-reinforced resins; however, the composition for fiber-reinforced resin is preferably used in fiber-reinforced resins containing a thermoplastic resin as a matrix resin.

### DESCRIPTION OF EMBODIMENTS

### [Composition for Fiber-Reinforced Resin (I)]

The composition for fiber-reinforced resin (I) according to the present invention contains a resin (A), and the resin (A) contains at least one resin (A) selected from the group consisting of rosin resins, petroleum resins, terpene resins, and hydrides of cyclic ketone-aldehyde resins (“component (A)” below).

### <Resin (A)>

The component (A) is not particularly limited as long as the component (A) is at least one resin selected from the group consisting of rosin resins, petroleum resins, terpene resins, and hydrides of cyclic ketone-aldehyde resins, and has a softening point of 80° C. to 180° C. In the present invention, the softening point is a value as measured by the ring and ball method (JIS K 5902). The component (A) may be a single member or a combination of two or more members.

A fiber-reinforced resin for which the composition for fiber-reinforced resin according to the present invention has been used exhibits excellent mechanical characteristics. The details are as explained below.

The component (A), which is at least one resin selected from the group consisting of rosin resins, petroleum resins, terpene resins, and hydrides of cyclic ketone-aldehyde resins, originally has high affinity for the matrix resin or fiber described later. Thus, it is assumed that because of the increased wettability between the matrix resin and the fiber through the component (A), the fiber-reinforced resin exhibits excellent mechanical strength.

The resin (A) has a softening point of 80° C. to 180° C. Due to the resin (A) having a softening point of 80° C. to 180° C. in the composition for fiber-reinforced resin (I), the fiber-reinforced resin exhibits excellent mechanical strength. If the resin (A) has a softening point of less than 80° C., the composition for fiber-reinforced resin may bleed out from the fiber-reinforced resin and make the fiber-reinforced resin sticky; this may decrease mechanical strength. If the resin (A) has a softening point of over 180° C., the composition for fiber-reinforced resin is difficult to melt, and difficult to show wettability to fibers.

### (Rosin Resins)

The rosin resins are not particularly limited, and various known rosin resins are usable.

Examples of rosin resins include the following:

Natural rosins

Natural rosins derived from Masson's pine, slash pine, Merkus pine, Khasi pine, loblolly pine, longleaf pine, etc. (gum rosin, tall oil rosin, and wood rosin);

Purified rosins

Purified rosins obtained by purifying the natural rosins by distillation under reduced pressure, steam distillation, extraction, recrystallization, etc. (natural rosins and purified rosins are collectively referred to as “unmodified rosins” below);

Hydrogenated rosins

Hydrogenated rosins obtained by subjecting the unmodified rosins to hydrogenation;

Disproportionated rosins

Disproportionated rosins obtained by subjecting the unmodified rosins to disproportionation;

Polymerized rosins

Polymerized rosins obtained by polymerizing the unmodified rosins;

α,β-Unsaturated carboxylic-acid-modified rosins

α,β-Unsaturated carboxylic-acid-modified rosins such as acrylic rosin, maleated rosin, and fumarated rosin;

Rosin esters

Esterified products of the rosins above (esterified products of these are referred to as “rosin esters” below);

Rosin phenol resins; and
Rosin diols.

These rosin resins may be used singly, or in a combination of two or more.

The resin (A) is preferably at least one member selected from the group consisting of α,β-unsaturated carboxylic-acid-modified rosins, rosin esters, rosin phenol resins, and rosin diols.

From the standpoint of excellent mechanical strength of the fiber-reinforced resin, the rosin resin is preferably at least one member selected from the group consisting of α,β-unsaturated carboxylic-acid-modified rosins, rosin esters, rosin phenol resins, and rosin diols; more preferably at least one member selected from the group consisting of α,β-unsaturated carboxylic-acid-modified rosins, unmodified rosin esters, hydrogenated rosin esters, disproportionated rosin esters, polymerized rosin esters, α,β-unsaturated carboxylic-acid-modified rosin esters, rosin phenol resins, and rosin diols; and from the same viewpoints, particularly preferably at least one member selected from the group consisting of α,β-unsaturated carboxylic-acid-modified rosins, hydrogenated rosin esters, disproportionated rosin esters, α,β-unsaturated carboxylic-acid-modified rosin esters, polymerized rosin esters, rosin phenol resins, and rosin diols.

The following describes α,β-unsaturated carboxylic-acid-modified rosins, unmodified rosin esters, hydrogenated rosin esters, disproportionated rosin esters, polymerized rosin esters, α,β-unsaturated carboxylic-acid-modified rosin esters, rosin phenol resins, and rosin diols.

### (α,β-Unsaturated Carboxylic-Acid-Modified Rosins)

An α,β-unsaturated carboxylic-acid-modified rosin can be obtained by performing addition reaction on the unmodified rosin or disproportionated rosin with an α,β-unsaturated carboxylic acid.

The α,β-unsaturated carboxylic acids are not particularly limited, and various known α,β-unsaturated carboxylic acids are usable.

Specific examples include acrylic acid, methacrylic acid, maleic acid, fumaric acid, itaconic acid, citraconic acid, muconic acid, maleic anhydride, itaconic anhydride, citraconic anhydride, and muconic anhydride. Of these, acrylic acid, maleic acid, maleic anhydride, and fumaric acid are preferable.

From the standpoint of excellent emulsifiability, the amount of the α,β-unsaturated carboxylic acid for use is typically about 1 part by mass to 20 parts by mass, and preferably about 1 part by mass to 3 parts by mass, per 100 parts by mass of the unmodified rosin. The α,β-unsaturated carboxylic acids may be used singly, or in a combination of two or more.

The method for producing the α,β-unsaturated carboxylic-acid-modified rosin is not particularly limited. For example, the α,β-unsaturated carboxylic-acid-modified rosin is produced by adding an α,β-unsaturated carboxylic acid to the unmodified rosin or disproportionated rosin melted by heating, and reacting the mixture at a temperature of about 180° C. to 240° C. for about 1 hour to 9 hours. The reaction may be performed with an inert gas such as nitrogen blown into a sealed reaction system.

The reaction above may be performed by using, for example, a known catalyst such as Lewis acid (e.g., zinc chloride, iron chloride, or tin chloride) or Brønsted acid (e.g., p-toluenesulfonic acid or methanesulfonic acid). The amount of such a catalyst is typically about 0.01 mass % to 10 mass % based on the unmodified rosin.

The α,β-unsaturated carboxylic-acid-modified rosins for use may be α,β-unsaturated carboxylic-acid-modified rosins that have been further subjected to hydrogenation, described later.

The α,β-unsaturated carboxylic-acid-modified rosins include resin acids derived from the unmodified rosins or disproportionated rosins.

The rosin ester is preferably at least one member selected from the group consisting of unmodified rosin esters, hydrogenated rosin esters, disproportionated rosin esters, polymerized rosin esters, and α,β-unsaturated carboxylic-acid-modified rosin esters.

### (Unmodified Rosin Esters)

An unmodified rosin ester can be obtained by reacting the unmodified rosin with an alcohol.

The reaction conditions for the unmodified rosin and alcohol may be the following: optionally adding an esterification catalyst to the unmodified rosin and alcohol in the presence or absence of a solvent, and allowing a reaction to proceed at about 250° C. to 280° C. for about 1 hour to 8 hours.

The alcohol is not particularly limited. Examples include monohydric alcohols such as methanol, ethanol, propanol, and stearyl alcohol; dihydric alcohols such as ethylene glycol, diethylene glycol, triethylene glycol, propylene glycol, neopentyl glycol, and dimer diol; trihydric alcohols such as glycerin, trimethylol ethane, and trimethylol propane; tetrahydric alcohols such as pentaerythritol, and diglycerin; and hexahydric alcohols such as dipentaerythritol. Of these, polyhydric alcohols having two or more hydroxyl groups are preferable, and glycerin and pentaerythritol are particularly more preferable. These alcohols may be used singly, or in a combination of two or more.

### (Hydrogenated Rosin Esters)

A hydrogenated rosin ester is obtained by subjecting the unmodified rosin to hydrogenation and further reacting the obtained hydrogenated rosin with an alcohol to esterify it.

The method for obtaining the hydrogenated rosin may be various known techniques. Specifically, for example, the unmodified rosin may be heated in the presence of a hydrogenation catalyst under hydrogen pressurization to allow a reaction (hydrogenation) to proceed.

The hydrogenation catalyst for use may be various known catalysts such as supported catalysts and metal powders. The supported catalysts include palladium-carbon, rhodium-carbon, ruthenium-carbon, and platinum-carbon. Metal powders include nickel, and platinum.

The amount of the catalyst for use is typically about 0.01 part by mass to 5 parts by mass, and preferably about 0.01 part by mass to 2 parts by mass, per 100 parts by mass of the rosin for use as a starting material.

The hydrogen pressure for hydrogenation of the unmodified rosin is about 2 MPa to 20 MPa, and preferably about 5 MPa to 20 MPa.

The reaction temperature for hydrogenation of the unmodified rosin is about 100° C. to 300° C., and preferably about 150° C. to 300° C.

The hydrogenation may be performed optionally with the unmodified rosin dissolved in a solvent. The solvent for use is not particularly limited as long as the solvent is inert to the reaction and easily dissolves the starting material or product. Specifically, for example, the solvent for use may be cyclohexane, n-hexane, n-heptane, decalin, tetrahydrofuran, dioxane, or a combination of two or more of these.

The amount of the solvent for use is not particularly limited. The amount of the solvent on a solids basis is typically 10 mass % or more, and preferably about 10 mass % to 70 mass % based on the unmodified rosin.

The reaction conditions for the hydrogenated rosin and the alcohol may be the following: optionally adding an esterification catalyst to the hydrogenated rosin and alcohol in the presence or absence of a solvent, and allowing a reaction to proceed at about 250° C. to 280° C. for about 1 hour to 8 hours.

The alcohol for use in esterifying the hydrogenated rosin is the same as those described above.

The order for performing the hydrogenation and the esterification is not limited to the example above. After esterification, hydrogenation may be performed. The obtained hydrogenated rosin ester may be further subjected to the hydrogenation above.

### (Disproportionated Rosin Esters)

A disproportionated rosin ester is obtained by subjecting the unmodified rosin to disproportionation and further reacting the obtained disproportionated rosin with an alcohol to esterify it.

The method for obtaining the disproportionated rosin may be various known techniques. Specifically, for example, the disproportionated rosin can be obtained by heating the unmodified rosin in the presence of a disproportionation catalyst to allow a reaction (disproportionation) to proceed.

Examples of disproportionation catalysts include various known disproportionation catalysts such as supported catalysts (e.g., palladium-carbon, rhodium-carbon, and platinum-carbon), metal powders (e.g., nickel, and platinum), and iodides (e.g., iodine, and iron iodide).

The amount of the catalyst for use is typically about 0.01 parts by mass to 5 parts by mass, and preferably about 0.01 parts by mass to 1 part by mass, per 100 parts by mass of the rosin for use as a starting material.

The reaction temperature for disproportionation of the unmodified rosin is about 100° C. to 300° C., and preferably about 150° C. to 290° C.

The reaction conditions for the disproportionated rosin and the alcohol may be the following: optionally adding an esterification catalyst to the disproportionated rosin and alcohol in the presence or absence of a solvent, and allowing a reaction to proceed at about 250° C. to 280° C. for about 1 hour to 8 hours.

The alcohol for use in esterifying the disproportionated rosin is the same as those described above.

The order for performing the disproportionation and the esterification is not limited to the example above. After esterification is performed, disproportionation may be performed.

### (Polymerized Rosin Esters)

A polymerized rosin ester is obtained by reacting a polymerized rosin with an alcohol. A polymerized rosin is a rosin derivative containing dimerized resin acid.

The method for producing the polymerized rosin may be a known method. Specifically, for example, the unmodified rosin as a starting material may be reacted in a solvent such as toluene or xylene containing a catalyst such as sulfuric acid, hydrogen fluoride, aluminum chloride, or titanium tetrachloride at a reaction temperature of about 40° C. to 160° C. for about 1 hour to 5 hours.

Specific examples of the polymerized rosin include gum-based polymerized rosins for which gum rosin is used as a starting material (e.g., trade name: Polymerized Rosin B-140, produced by Rosin Chemical (Wuping) Co., Ltd.), tall oil-based polymerized rosins for which tall oil rosin is used (e.g., trade name: silver tack 140, produced by Arizona Chemical), and wood-based polymerized rosins for which wood rosin is used (e.g., trade name Dimerex, produced by Hercules).

The polymerized rosin that has been subjected to various treatments such as α,β-unsaturated carboxylic acid modification including hydrogenation, disproportionation, acrylation, maleation, and fumarization may be used as the above polymerized rosin. The various treatments can also be used singly, or in a combination of two or more.

The reaction conditions for the polymerized rosin and the alcohol may be the following: optionally adding an esterification catalyst to the polymerized rosin and alcohol in the presence or absence of a solvent, and allowing a reaction to proceed at about 250° C. to 280° C. for about 1 hour to 8 hours. The polymerized rosin in combination with the unmodified rosin may also be reacted with an alcohol.

The alcohol for use in esterifying the polymerized rosin is the same as those described above.

The order for the polymerization and the esterification is not limited to the example above. After esterification is performed, polymerization may be performed.

### (α,β-Unsaturated Carboxylic-Acid-Modified Rosin Esters)

An α,β-unsaturated carboxylic-acid-modified rosin ester can be obtained by reacting the α,β-unsaturated carboxylic-acid-modified rosin with an alcohol.

The reaction conditions for the α,β-unsaturated carboxylic-acid-modified rosin and alcohol are not particularly limited. For example, an alcohol may be added to an α,β-unsaturated carboxylic-acid-modified rosin melted by heating, and then a reaction may be performed at a temperature of about 250° C. to 280° C. for about 15 hours to 20 hours. The reaction may be performed with an inert gas such as nitrogen blown into a sealed reaction system, and the catalyst described above may also be used.

The alcohol for use in esterifying the α,β-unsaturated carboxylic-acid-modified rosin is the same as those described above.

### (Rosin Phenol Resins)

A rosin phenol resin can be obtained by reacting the unmodified rosin with a phenol.

The phenol for use is not particularly limited, and various known phenols are usable. Specific examples include alkyl phenols such as cresol, butylphenol, octylphenol, and nonylphenol, phenols, bisphenols, and naphthols. These phenols can be used singly, or in a combination of two or more.

The amount of the phenol for use in reaction is typically about 0.8 mol to 1.5 mol per mol of the starting material rosin.

The method for producing the rosin phenol resin is not particularly limited. For example, the unmodified rosin and phenol can be heated to allow a reaction to proceed optionally in the presence of an acid catalyst.

The reaction can be performed at a temperature of typically about 180° C. to 350° C. for about 6 hours to 18 hours.

The acid catalyst for use in the reaction is not particularly limited. Examples include inorganic acid catalysts such as sulfuric acid, hydrogen chloride, and boron trifluoride, and organic acid catalysts such as p-toluenesulfonic acid, and methanesulfonic acid. The amount of the acid catalyst for use is about 0.01 parts by mass to 1.0 part by mass, per 100 parts by mass of the unmodified rosin.

The rosin phenol resin may be a rosin phenol obtained by further reacting the resin obtained by the reaction above with an alcohol to esterify the resin. The alcohol for use in this reaction is the same as those described above.

### (Rosin Diols)

A rosin diol is a compound having at least two rosin skeletons in its molecule and at least two hydroxyl groups in its molecule.

Examples of rosin diols include reaction products of the unmodified rosin, hydrogenated rosin, or disproportionated rosin with an epoxy resin (see JPH05-155972A).

Examples of epoxy resins include bisphenol-type epoxy resins, novolac-type epoxy resins, resorcinol-type epoxy resins, phenol aralkyl-type epoxy resins, naphthol aralkyl-type epoxy resins, aliphatic polyepoxy compounds, alicyclic epoxy compounds, glycidyl amine-type epoxy compounds, glycidyl ester-type epoxy compounds, monoepoxy compounds, naphthalene-type epoxy compounds, biphenyl-type epoxy compounds, epoxidized polybutadiene, epoxidized styrene-butadiene-styrene block copolymers, epoxy group-containing polyester resins, epoxy group-containing polyurethane resins, epoxy group-containing acrylic resins, stilbene-type epoxy compounds, triazine-type epoxy compounds, fluorene-type epoxy compounds, triphenol methane-type epoxy compounds, alkyl-modified triphenol methane-type epoxy compounds, dicyclopentadiene-type epoxy compounds, and aryl alkylene-type epoxy compounds.

Examples of bisphenol-type epoxy resins include bisphenol A-type epoxy resins, bisphenol F-type epoxy resins, bisphenol S-type epoxy resins, bisphenol AD-type epoxy resins, hydrogenated bisphenol A-type epoxy resins, hydrogenated bisphenol F-type epoxy resins, hydrogenated bisphenol AD-type epoxy resins, and tetrabromo bisphenol A-type epoxy resins.

Examples of novolac-type epoxy resins include cresol novolac-type epoxy resins, phenol novolac-type epoxy resins, α-naphthol novolac-type epoxy resins, bisphenol A-type novolac-type epoxy resins, and brominated phenol novolac-type epoxy resins.

Examples of aliphatic polyepoxy compounds include 1,4-butanediol diglycidyl ether, 1,6-hexanediol diglycidyl ether, ethylene glycol diglycidyl ether, propylene glycol diglycidyl ether, polyethylene glycol diglycidyl ether, propylene glycol diglycidyl ether, neopentyl glycol diglycidyl ether, glycerol diglycidyl ether, glycerol triglycidyl ether, trimethylol propane diglycidyl ether, trimethylol propane triglycidyl ether, diglycerol triglycidyl ether, sorbitol tetraglycidyl ether, and diglycidyl ether.

Examples of alicyclic epoxy compounds include 3,4-epoxycyclohexylmethyl-3′,4′-epoxycyclohexane carboxylate, 2-(3,4-epoxycyclohexyl-5,5-spiro-3,4-epoxy) cyclohexane-meta-dioxane, bis(3,4-epoxycyclohexylmethyl)adipate, bis(3,4-epoxy-6-methylcyclohexylmethyl)adipate, 3,4-epoxy-6-methylcyclohexyl-3′,4′-epoxy-6′-methylcyclohexane carboxylate, methylenebis(3,4-epoxycyclohexane), dicyclopentadiene diepoxide, ethylene glycol di(3,4-epoxycyclohexylmethyl) ether, ethylene bis(3,4-epoxycyclohexanecarboxylate), and lactone-modified 3,4-epoxycyclohexylmethyl-3′,4′-epoxycyclohexane carboxylate.

Examples of glycidyl amine-type epoxy compounds include tetraglycidyl diamino diphenyl methane, triglycidyl para-aminophenol, triglycidyl meta-aminophenol, and tetraglycidyl meta-xylylene diamine.

Examples of glycidyl ester-type epoxy compounds include diglycidyl phthalate, diglycidyl hexahydrophthalate, and diglycidyl tetrahydrophthalate.

The method for producing the rosin diol is not particularly limited. The method is, for example, ring-opening addition reaction of the unmodified rosin, hydrogenated rosin, or disproportionated rosin with an epoxy resin in the presence of a catalyst at 120° C. to 200° C.

The catalyst for use is, for example, an amine-based catalyst, such as trimethylamine, triethylamine, tributylamine, benzyl dimethylamine, pyridine, or 2-methylimidazole, a quaternary ammonium salt, such as benzyl trimethyl ammonium chloride, Lewis acid, boric acid ester, an organic metal compound, or an organic metal salt.

### (Physical Properties of Rosin Resin (Resin (A))

The rosin resin has a softening point of 80° C. to 180° C. From the standpoint of excellent mechanical strength of the fiber-reinforced resin and excellent handling and processability, the rosin resin preferably has a softening point of about 80° C. to 160° C., and more preferably about 90° C. to 160° C.

The physical properties of the rosin resin other than the softening point are not particularly limited.

From the standpoint of excellent mechanical strength of the fiber-reinforced resin, the rosin resin preferably has a hydroxyl value of about 10 mgKOH/g to 150 mgKOH/g. From the standpoint of excellent mechanical strength of the fiber-reinforced resin, the rosin resin preferably has an acid value of about 0.5 mgKOH/g to 310 mgKOH/g. In the present invention, the hydroxyl value and acid value are values as measured in accordance with JIS K 0070.

From the standpoint of excellent design, the rosin resin has a color tone of preferably about 10 Hazen to 400 Hazen, and more preferably about 10 Hazen to 200 Hazen. In the present specification, the color tone is a value as measured in Hazen unit in accordance with JIS K 0071-3.

From the standpoint of excellent handling and processability, the rosin resin has a weight average molecular weight of preferably about 300 to 3,000, and more preferably about 350 to 2,000. The weight average molecular weight is a value as determined by gel permeation chromatography (GPC) based on the polystyrene standards.

### (Petroleum Resins)

The resin (A) is preferably a petroleum resin.

The petroleum resins are not particularly limited, and various known petroleum resins are usable. Examples of petroleum resins include aliphatic petroleum resins, alicyclic petroleum resins, aromatic petroleum resins, aliphatic-aromatic petroleum resins, hydroxy-containing petroleum resins, and hydrides thereof (these hydrides are referred to as “hydrogenated petroleum resins” below). The petroleum resins may be used singly, or in a combination of two or more.

Examples of aliphatic petroleum resins include C5 petroleum resins obtained from C5 oil fractions of naphtha.

Examples of C5 oil fractions include C₄₋₆ conjugated diolefinic unsaturated hydrocarbons such as isoprene, trans-1,3-pentadiene, cis-1,3-pentadiene, cyclopentadiene, and methyl cyclopentadiene; C₄₋₆ monoolefinic unsaturated hydrocarbons such as butene, 2-methyl-1-butene, 2-methyl-2-butene, 1-pentene, 2-pentene, and cyclopentene; aliphatic saturated hydrocarbons such as cyclopentane, 2-methylpentane, 3-methylpentane, and n-hexane; and mixtures thereof.

Examples of alicyclic petroleum resins include dicyclopentadiene petroleum resins obtained from cyclopentadiene oil fractions of naphtha. Examples of cyclopentadiene oil fractions include cyclopentadiene, methyl cyclopentadiene, ethyl cyclopentadiene, and dimers, trimers, and co-dimers thereof, and mixtures thereof. Examples of dimers include dicyclopentadiene.

Examples of aromatic petroleum resins include C9 petroleum resins obtained from C9 oil fractions of naphtha, and copolymers obtained by polymerizing a C9 petroleum resin, or two or more C9 petroleum resins. Examples of C₉ oil fractions include C₈ aromatic compounds such as styrene; C₉ aromatic compounds such as α-methylstyrene, β-methylstyrene, vinyltoluene, and indene; C₁₀ aromatic compounds such as 1-methylindene, 2-methylindene, and 3-methylindene; C₁₁ aromatic compounds such as 2,3-dimethylindene, and 2,5-dimethylindene; and mixtures thereof.

In the present specification, a compound having an aromatic ring and a vinyl group moiety, such as styrene, α-methylstyrene, β-methylstyrene, or vinyltoluene, is also referred to as an aromatic vinyl compound.

Examples of aliphatic-aromatic petroleum resins include C5/C9 copolymerized petroleum resins obtained from C5 oil fractions and C9 oil fractions.

The hydroxy-containing petroleum resin is not particularly as long as the hydroxy-containing petroleum resin has at least two hydroxyl groups per molecule, and various known hydroxy-containing petroleum resins are usable. The hydroxy-containing petroleum resins may be used singly, or in a combination of two or more.

Examples of hydroxy-containing petroleum resins include hydroxy-containing C5 petroleum resins, hydroxy-containing dicyclopentadiene petroleum resins, hydroxy-containing C9 petroleum resins, hydroxy-containing C5-C9 petroleum resins, and hydroxy-containing dicyclopentadiene-C9 petroleum resins.

Examples of hydroxy-containing C5 petroleum resins include reaction products of a C5 oil fraction with a hydroxy-containing compound.

Examples of hydroxy-containing compounds include phenolic compounds, and hydroxy-containing olefin compounds. Examples of phenolic compounds include phenol, cresol, xylenol, amyl phenol, bisphenol A, vinyl phenol, and alkyl phenols such as butyl phenol, octyl phenol, nonyl phenol, and dodecyl phenol. Examples of hydroxy-containing olefin compounds include allyl alcohol compounds, and hydroxy-containing mono(meth)acrylate.

Examples of allyl alcohol compounds include allyl alcohols, 2-methyl-2-propen-1-ol, 3-methyl-2-propen-1-ol, 2-buten-1-ol, 2-penten-1-ol, 2-hexen-1-ol, 5-methyl-2-hexen-1-ol, 4-cyclohexyl-2-buten-1-ol, 2,5-hexadien-1-ol, 2,5-heptadien-1-ol, 2,6-heptadien-1-ol, 2,5-octadien-1-ol, 2,6-octadien-1-ol, 2,7-octadien-1-ol, 4-(1-cyclohexenyl)-2-buten-1-ol, 4-phenyl-2-buten-1-ol, 4-naphthyl-2-buten-1-ol, 3,7-dimethyl-2,7-octadien-1-ol, 3,7-dimethyl-2,6-octadien-1-ol, 3,7,11-trimethyl-2,6,10-dodecatrien-1-ol, 1-penten-3-ol, 1-hexen-3-ol, 5-methyl-1-hexen-3-ol, 4-cyclohexyl-1-buten-3-ol, 1,5-hexadien-3-ol, 1,5-heptadien-3-ol, 1,6-heptadien-3-ol, 1,5-octadien-3-ol, 1,6-octadien-3-ol, 1,7-octadien-3-ol, 4-(1-cyclohexenyl)-1-buten-3-ol, cinnamyl alcohol, 4-phenyl-1-buten-3-ol, 4-naphthyl-1-buten-3-ol, 3,7-dimethyl-2,7-octadien-1-ol, 3,7-dimethyl-1,6-octadien-3-ol, and 3,7,11-trimethyl-1,6,10-dodecatrie-3-ol.

Examples of hydroxy-containing mono(meth)acrylate include 2-hydroxyethyl (meth)acrylate, 3-hydroxypropyl (meth)acrylate, 4-hydroxybutyl (meth)acrylate, 2-hydroxypropyl (meth)acrylate, 2-hydroxybutyl (meth)acrylate, 3-hydroxybutyl (meth)acrylate, and hydroxycyclohexyl (meth)acrylate.

Examples of hydroxy-containing dicyclopentadiene petroleum resins include reaction products of the cyclopentadiene oil fractions described above with the hydroxy-containing compounds described above.

Examples of hydroxy-containing C9 petroleum resins include reaction products of the C9 oil fraction described above with the hydroxy-containing compound described above.

Examples of hydroxy-containing C5-C9 petroleum resins include reaction products of the C5 oil fractions described above, C9 oil fractions, and the hydroxy-containing compounds described above.

Examples of hydroxy-containing dicyclopentadiene-C9 petroleum resins include reaction products of the cyclopentadiene oil fractions described above, the C9 oil fractions described above, and the hydroxy-containing compounds described above.

The method for producing the hydroxy-containing petroleum resin is not particularly limited, and various known methods are usable. Specific examples include cationic polymerization using a Friedel-Crafts catalyst such as aluminum chloride or boron trifluoride in the presence of an oil fraction and the hydroxy-containing compound described above; and thermal polymerization in an autoclave in the presence of an oil fraction and the hydroxy-containing compound described above.

From the standpoint of excellent mechanical strength of the fiber-reinforced resin, the hydroxy-containing petroleum resin is preferably a hydroxy-containing dicyclopentadiene petroleum resin, or a hydroxy-containing C9 petroleum resin. From the same viewpoint, the hydroxy-containing dicyclopentadiene petroleum resin is more preferably a reaction product of a cyclopentadiene oil fraction with an allyl alcohol. From the same viewpoint, the hydroxy-containing C9 petroleum resin is more preferably a reaction product of a C9 oil fraction with a phenol compound, or a reaction product of an aromatic vinyl compound with an allyl alcohol, and particularly preferably a reaction product of styrene with an allyl alcohol (styrene-allyl-alcohol copolymer resin).

The hydrogenated petroleum resins can be obtained by using various known techniques. Specifically, for example, hydrogenated petroleum resins can be obtained by subjecting the various petroleum resins described above (aliphatic petroleum resins, alicyclic petroleum resins, aromatic petroleum resins, aliphatic-aromatic petroleum resins, hydroxy-containing petroleum resins) to hydrogenation by using known hydrogenation conditions.

Examples of the hydrogenation conditions include a method of heating the petroleum resin to about 200° C. to 350° C. in the presence of a hydrogenation catalyst under a hydrogen partial pressure of about 0.2 MPa to 30 MPa.

Examples of hydrogenation catalysts include metals such as nickel, palladium, cobalt, ruthenium, platinum, and rhodium, and oxides of these metals. Typically, the amount of the hydrogenation catalyst for use is preferably about 0.01 parts by mass to 10 parts by mass per 100 parts by mass of the starting material resin.

The hydrogenation above is performed with the various petroleum resins (aliphatic petroleum resins, alicyclic petroleum resins, aromatic petroleum resins, aliphatic-aromatic petroleum resins, and hydroxy-containing petroleum resins) melted or dissolved in a solvent.

The solvent for dissolving the petroleum resins is not particularly limited, and can be any solvent that is inert to the reaction and that easily dissolves the starting material or product. For example, solvents such as cyclohexane, n-hexane, n-heptane, decalin, tetrahydrofuran, and dioxane can be used singly, or in a combination of two or more.

The amount of the solvent for use is not particularly limited and is typically about 10 mass % or more, and preferably about 10 mass % to 70 mass % on a solids basis based on the petroleum resin.

The hydrogenation conditions above describe the case in which a batch process is used as a reaction process. However, the reaction process for use may also be a flow process (e.g., a fixed-bed process and a fluidized-bed process).

From the standpoint of excellent mechanical strength of the fiber-reinforced resin, the petroleum resin is preferably a C5 petroleum resin, a C9 petroleum resin, a hydroxy-containing petroleum resin, a hydrogenated petroleum resin from a C9 petroleum resin, or a hydrogenated petroleum resin from a hydroxy-containing petroleum resin.

From the standpoint of handling, the petroleum resin is more preferably a hydrogenated petroleum resin from a C9 petroleum resin, or a hydrogenated petroleum resin from a hydroxy-containing petroleum resin. From the same viewpoint, the hydrogenated petroleum resin from a hydroxy-containing petroleum resin is more preferably a hydride from a reaction product between a cyclopentadiene oil fraction and an allyl alcohol, or a hydride of a reaction product between an aromatic vinyl compound and an allyl alcohol.

### (Physical Properties of Petroleum Resin (Resin (A))

The petroleum resin has a softening point of 80° C. to 180° C. From the standpoint of excellent handling and processability, the petroleum resin preferably has a softening point of about 80° C. to 140° C., and more preferably about 90° C. to 135° C.

The physical properties of the petroleum resin other than the softening point are not particularly limited.

From the standpoint of excellent mechanical strength of the fiber-reinforced resin and excellent handling and processability, the petroleum resin has a weight average molecular weight of preferably about 500 to 3,000, and more preferably about 500 to 2,000. The weight average molecular weight is a value as determined by gel permeation chromatography (GPC) based on the polystyrene standards.

From the standpoint of excellent handling and processability, the petroleum resin has a number average molecular weight of preferably about 200 to 2,800, and more preferably about 250 to 1,800. The number average molecular weight is a value as determined by gel permeation chromatography (GPC) based on the polystyrene standards.

From the standpoint of excellent design, the petroleum resin has a color tone of preferably about 10 Hazen to 400 Hazen, and more preferably about 10 Hazen to 200 Hazen. In the present specification, the color tone is a value as measured in Hazen unit in accordance with JIS K 0071-3.

From the standpoint of excellent mechanical strength of the fiber-reinforced resin, the hydroxy-containing petroleum resin has a hydroxyl value of preferably about 10 mgKOH/g to 310 mgKOH/g, and more preferably about 50 mgKOH/g to 250 mgKOH/g.

### (Terpene Resins)

The terpene resins are not particularly limited, and various known terpene resins are usable. Examples of terpene resins include resins obtained by copolymerizing a known terpene with a phenol. The terpene resins may be hydrogenated. The terpene resins may be used singly, or in a combination of two or more.

### (Physical Properties of Terpene Resin (Resin (A))

The terpene resin has a softening point of 80° C. to 180° C.; from the standpoint of excellent mechanical strength of the fiber-reinforced resin and excellent handling and processability, the terpene resin has a softening point of preferably about 80° C. to 140° C., and more preferably about 90° C. to 135° C.

### (Hydride of Cyclic Ketone-Aldehyde Resins)

The hydrides of cyclic ketone-aldehyde resins are not particularly limited as long as the hydrides are a resin obtained by hydrogenating a cyclic ketone-aldehyde resin, and various known hydrides are usable. The hydrides may be used singly, or in a combination of two or more.

The cyclic ketone-aldehyde resins are not particularly limited, and various known cyclic ketone-aldehyde resins are usable. Examples of cyclic ketone-aldehyde resins include reaction products of cyclic ketones with aldehyde compounds. The cyclic ketone-aldehyde resins may be used singly, or in a combination of two or more.

Examples of cyclic ketones include cyclopentanone, cyclohexanone, methylcyclohexanone, cycloheptanone, cyclooctanone, and acetophenone. Examples of aldehyde compounds include formaldehyde, paraform, formalin, and acetaldehyde.

From the standpoint of ease of access and excellent mechanical strength of the fiber-reinforced resin, the cyclic ketone-aldehyde resin is preferably a cyclohexanone-formaldehyde resin, which is a reaction product of a cyclohexanone with a formaldehyde (formaldehyde, paraform, or formalin), or an acetophenone-formaldehyde resin, which is a reaction product of an acetophenone with a formaldehyde (formaldehyde, paraform, or formalin).

The method for producing the cyclic ketone-aldehyde resin is not particularly limited, and various known methods are usable. Specific examples include a method of reacting the cyclic ketone with the aldehyde compound in the presence of a basic catalyst by a known method. Examples of alkaline catalysts include sodium hydroxide, and potassium hydroxide.

A hydride of the cyclic ketone-aldehyde resin can be obtained by subjecting the carbonyl group of the cyclic ketone-aldehyde resin to hydrogenation reduction by using known hydrogenation conditions.

The hydrogenation conditions may be, for example, the following: a method of heating the cyclic ketone-aldehyde resin to about 30° C. to 250° C. under a hydrogen partial pressure of about 0.1 MPa to 20 MPa in the presence of a hydrogenation catalyst.

Examples of hydrogenation catalysts include metals such as nickel, palladium, cobalt, ruthenium, platinum, and rhodium, and nitric acid salts, acetic acid salts, chlorides, and oxides of these metals. The hydrogenation catalyst may be supported by a carrier such as activated carbon, silica, alumina, silica alumina, titania, diatomaceous earth, and a zeolite, which are porous and have a large surface area.

Typically, the amount of the hydrogenation catalyst for use is preferably about 0.005 parts by mass to 2 parts by mass per 100 parts by mass of the starting material resin.

The hydrogenation reduction above may be performed optionally with the cyclic ketone-aldehyde resin dissolved in a solvent. The solvent for use can be any solvent that is inert to the reaction and that easily dissolves the starting material or product.

Specific examples include alcohol compounds such as methanol, ethanol, propanol, butanol, pentanol, and cyclohexanol, halogenated compounds such as chloroform, carbon tetrachloride, methylene chloride, trichloromethane, and dichloromethane, and hydrocarbon compounds such as cyclohexane, n-hexane, n-heptane, and n-octane.

The amount of the solvent for use is not particularly limited, and is typically 10 mass % or more, and preferably about 10 mass % to 70 mass %, on a solids basis, based on the cyclic ketone-aldehyde resin.

The hydrogenation conditions above describe the case in which a batch process is used as a reaction process. However, the reaction process for use may also be a flow process (e.g., a fixed-bed process and a fluidized-bed process).

The hydrogenation rate of a hydride of a cyclic ketone-aldehyde resin is not particularly limited. The hydrogenation rate is preferably about 40% to 100% from the standpoint of decreasing decomposition of the resin during heating. The hydrogenation rate refers to a reduction rate of the carbonyl groups contained in the cyclic ketone-aldehyde resin into hydroxyl groups.

### (Physical Properties of Hydrides of Cyclic Ketone-Aldehyde Resins (Resin (A))

The hydrides of the cyclic ketone-aldehyde resin have a softening point of 80° C. to 180° C. From the standpoint of excellent mechanical strength of the fiber-reinforced resin and excellent handling and processability, the hydrides of the cyclic ketone-aldehyde resin have a softening point of preferably about 80° C. to 140° C., and more preferably about 90° C. to 135° C.

The physical properties of the hydrides of the cyclic ketone-aldehyde resin other than the softening point are not particularly limited. From the standpoint of excellent mechanical strength of the fiber-reinforced resin, the hydrides of the cyclic ketone-aldehyde resin have a hydroxyl value of preferably about 50 mgKOH/g to 400 mgKOH/g.

From the standpoint of excellent design, the hydrides of the cyclic ketone-aldehyde resin have a color tone of preferably about 10 Hazen to 400 Hazen, and more preferably about 10 Hazen to 200 Hazen.

### (Emulsions)

The composition for fiber-reinforced resin (I) according to the present invention can be any composition that contains the component (A). The composition for fiber-reinforced resin (I) according to the present invention preferably further contains a surfactant (B), and is an emulsion (simply “emulsion” below) containing the component (A) and the surfactant (B) (“component (B)” below).

Because it is in the form of an emulsion, the composition for fiber-reinforced resin can reduce the use of a solvent in the production processes of the fiber-reinforced resin, thus improving the working conditions. The composition for fiber-reinforced resin in the form of an emulsion eliminates the need for handling melted, highly viscous component (A), and is easy to adhere to fibers due to its improved ease in handling.

### (Surfactant (B))

The component (B) is not particularly limited, and various known substances are usable. Specific examples include high-molecular-weight emulsifiers, low-molecular-weight anionic emulsifiers, and low-molecular-weight nonionic emulsifiers, which are obtained by polymerizing a monomer. These emulsifiers can be used singly, or in a combination of two or more. Of these, from the standpoint of emulsifiability, low-molecular-weight anionic emulsifiers are preferable.

Examples of monomers for use in producing the high-molecular-weight emulsifiers include (meth)acrylic acid ester monomers such as methyl (meth)acrylate, ethyl (meth)acrylate, 2-ethylhexyl (meth)acrylate, and cyclohexyl (meth)acrylate; monocarboxylic acid vinyl monomers such as (meth)acrylic acid, and crotonic acid; dicarboxylic acid vinyl monomers such as maleic acid, maleic anhydride, and itaconic acid; sulfonic acid vinyl monomers such as vinyl sulfonic acid, styrene sulfonic acid, and (meth)allyl sulfonic acid; alkali metal salts, alkaline-earth metal salts, and ammonium salts of these organic acids, and salts of organic bases; (meth)acrylamide monomers such as (meth)acrylamide, dimethyl (meth)acrylamide, isopropyl (meth)acrylamide, diacetone (meth)acrylamide, and N-methylol (meth)acrylamide; nitrile monomers such as (meth)acrylonitrile; vinyl ester monomers such as acryloyl morpholine, and vinyl acetate; hydroxy-containing (meth)acrylic acid ester monomers such as 2-hydroxyethyl (meth)acrylate, and 2-hydroxypropyl (meth)acrylate; styrenes such as styrene, α-methylstyrene, t-butylstyrene, dimethylstyrene, acetoxystyrene, hydroxystyrene, vinyltoluene, and chlorovinyl toluene; and other monomers such as methyl vinyl ether, glycidyl (meth)acrylate, urethane acrylate, C₆₋₂₂ α-olefins, and vinyl pyrrolidone. These can be used singly, or in a combination of two or more.

The polymerization method includes solution polymerization, suspension polymerization, and emulsion polymerization using a reactive emulsifier or non-reactive emulsifier other than the high-molecular-weight emulsifiers described later.

The weight average molecular weight of the thus-obtained high-molecular-weight emulsifier is preferably, but not particularly limited to, typically about 1,000 to 500,000 from the standpoint of emulsifiability or mechanical stability of the emulsion. The weight average molecular weight is a value determined by gel permeation chromatography (GPC) based on polyethylene glycol standards.

The reactive emulsifier other than the high-molecular-weight emulsifier is, for example, an emulsifier having a hydrophilic group (e.g., a sulfonic acid group, and a carboxyl group) and a hydrophobic group (e.g., an alkyl group, and a phenyl group), with a carbon-carbon double bond in its molecule.

Examples of low-molecular-weight anionic emulsifiers include dialkyl sulfosuccinic acid ester salts, alkane sulfonic acid salts, α-olefin sulfonic acid salts, polyoxyethylene alkyl ether sulfosuccinic acid ester salts, polyoxyethylene styryl phenyl ether sulfosuccinic acid ester salts, naphthalene sulfonic acid formalin condensates, polyoxyethylene alkyl ether sulfuric acid ester salts, polyoxyethylene dialkyl ether sulfuric acid ester salts, polyoxyethylene trialkyl ether sulfuric acid ester salts, and polyoxyethylene alkyl phenyl ether sulfuric acid ester salts.

Examples of low-molecular-weight nonionic emulsifiers include polyoxyethylene alkyl ether, polyoxyethylene styryl phenyl ether, and polyoxyethylene sorbitan fatty acid esters.

The emulsifiers other than the high-molecular-weight emulsifiers can be used singly, or two or more of them can be suitably selected for use in combination.

The amount of the component (B) for use is about 1 part by mass to 10 parts by mass, and preferably 2 parts by mass to 8 parts by mass, on a solids basis, per 100 parts by mass of the component (A). An amount of the component (B) of 1 part by mass or more ensures emulsification, and an amount of the component (B) of 10 parts by mass or less results in the fiber-reinforced resin having excellent mechanical strength.

The emulsion above is prepared by emulsifying the component (A) in water in the presence of the component (B). The emulsification method is not particularly limited, and can be a known emulsification method, such as high-pressure emulsification or phase inversion emulsification.

High-pressure emulsification is a method including the following: preparing a substance to be emulsified in its liquid form, mixing the substance with an emulsifier and water beforehand, finely emulsifying the mixture with a high-pressure emulsifying device, and optionally removing the solvent. Although the method for preparing the substance to be emulsified in its liquid form may be performed only by heating, heating after dissolving it in a solvent, or mixing it with a non-volatile substance such as a plasticizer and heating the mixture, the method is preferably performed only by heating.

The solvent includes organic solvents capable of dissolving substances to be emulsified, such as toluene, xylene, methyl cyclohexane, or ethyl acetate.

Phase inversion emulsification is a method including the following: heating and melting a substance to be emulsified, adding an emulsifier and water with stirring to first form a W/O emulsion, and then inverting the phase into an O/W emulsion, for example, by adding water or changing temperature.

### (Physical Properties of Emulsion)

The physical properties of the emulsion are not particularly limited. Although the solids concentration of the emulsion is not particularly limited, the emulsion is typically adjusted for use so as to have a solids content of about 20 mass % to 70 mass %.

The emulsion typically has a volume average particle size of about 0.1 μm to 2 μm, and the greatest part of the emulsion is homogeneously dispersed in the form of particles with a volume average particle size of 1 μm or less. However, the volume average particle size is preferably 0.7 μm or less for storage stability.

Additionally, the emulsion has a white or milky white appearance with a pH of about 2 to 10 and a viscosity of typically about 10 mPa·s to 1,000 mPa·s (at a temperature of 25° C. and a concentration of 50 mass %).

The emulsion may optionally contain various additives such as an antifoaming agent, a thickening agent, a filler, an antioxidant, a waterproofing agent, and a film-forming aid, and a pH adjuster such as ammonia water and sodium bicarbonate as long as the effect of the present invention is not impaired.

### (Additives)

The composition for fiber-reinforced resin may optionally contain various known additives as long as the effect of the present invention is not impaired. Examples of additives include a surfactant other than the component (B), an antifoaming agent, a pH adjuster, an antimicrobial agent, a fungicide, a colorant, an antioxidant, a deodorizer, an organic solvent described later, and a flame retardant. The additives can be used singly, or in a combination of two or more.

### [Fiber-Reinforced Resin]

The fiber-reinforced resin according to the present invention contains the composition for fiber-reinforced resin (I) described above, a fiber (II), and a matrix resin (III).

### <Fiber (II)>

The fiber is not particularly limited, and various known fibers are usable. Examples of fibers include inorganic fibers such as carbon fiber, alumina fiber, glass fiber, rock wool, potassium titanate fiber, zirconia fiber, ceramic fiber, silicon fiber, silicon nitride fiber, silica-alumina fiber, kaolin fiber, bauxite fiber, kayanoid fiber, boron fiber, boron nitride fiber, magnesia fiber, and potassium titanate whiskers; and organic fibers such as polyester fiber, polyamide fiber, polyimide fiber, polyvinyl-alcohol-modified fiber, polyvinyl chloride fiber, polypropylene fiber, polybenzimidazole fiber, acrylic fiber, phenol fiber, nylon fiber, and cellulose (nano)fiber. These fibers can be used singly, or in a combination of two or more.

The fiber (II) is preferably at least one fiber selected from the group consisting of carbon fiber and glass fiber.

The carbon fiber is not particularly limited, and various known carbon fibers are usable. The carbon fiber for use is, for example, polyacrylonitrile (PAN) carbon fiber, pitch-based carbon fiber, or vapor-grown carbon fiber. The glass fiber for use is, for example, glass fiber typically used in reinforcing resin.

The fiber diameter of the fiber is not particularly limited. The lower limit of the fiber diameter is preferably 1 nm or more, more preferably 5 nm or more, and particularly preferably 10 nm or more. The upper limit of the fiber diameter is preferably 10 mm or less, more preferably 5 mm or less, still more preferably 3 mm or less, and particularly preferably 1 mm or less. The fiber diameter of the fiber can be measured by a known method. Specifically, the fiber diameter can be measured, for example, by observing the fiber with a microscope.

The fiber may optionally be modified on its surface with a functional group. Examples of functional groups include (meth)acryloyl groups, amide groups, amino groups, isocyanate groups, imide groups, urethane groups, ether groups, epoxy groups, carboxy groups, hydroxyl groups, and acid anhydride groups.

The method for introducing the functional group into the fiber is not particularly limited. Examples include a method of subjecting the fiber to plasma treatment, ozone treatment, or corona treatment, and further optionally subjecting the fiber to chemical etching treatment; a method of directly reacting the fiber with a sizing agent to incorporate the functional group; and a method of applying a sizing agent to the fiber or impregnating the fiber with a sizing agent and optionally solidifying the sizing agent.

The type of the sizing agent for use is, for example, one member, or two or more members selected from the group consisting of acids, acid anhydrides, alcohols, halogenation reagents, isocyanates, cyclic ethers such as alkoxysilane and oxirane (epoxy), epoxy resins, urethane resins, urethane-modified epoxy resins, epoxy-modified urethane resins, amine-modified aromatic epoxy resins, acrylic resins, polyester resins, phenol resins, polyamide resins, polycarbonate resins, polyimide resins, polyether imide resins, bismaleimide resins, polysulfone resins, polyethersulfone resins, polyvinyl alcohol resins, and polyvinyl pyrrolidone resins. The sizing agent is different from the composition for fiber-reinforced resin according to the present invention.

The form of the fiber is not particularly limited. Specific examples include a UD (uni-directional) material prepared by aligning fibers in one direction, cloth materials (woven fabrics) made of woven fibers, nonwoven fabrics formed of fibers, and chopped strands formed of chopped fibers.

The fiber is preferably carbon fiber from the standpoint of light weight and high rigidity required in the fiber-reinforced resin.

The fiber is preferably glass fiber from the standpoint of excellent rigidity and design of the fiber-reinforced resin. When the fiber-reinforced resin according to the present invention is produced by melt-kneading using glass fiber, the glass fiber is well dispersed in the matrix resin. This reduces fuzzing of the glass fiber. Thus, when a fiber-reinforced resin containing glass fiber is coated with paint, the paint can be uniformly applied, which results in excellent design.

The fiber is preferably glass fiber from the standpoint of excellent low-dielectric properties of the fiber-reinforced resin. When the fiber-reinforced resin according to the present invention is produced by melt-kneading using glass fiber, the glass fiber is well dispersed in the matrix resin. Thus, the obtained molded article has fewer variations in the low-dielectric properties. Such a fiber-reinforced resin with excellent low-dielectric properties can reduce transmission loss of high-frequency signals, and is thus suitable for use in electronic devices for high frequencies (e.g., 5G), including components of antennas and mobile terminals, such as smartphones.

### <Matrix Resin (III)>

Examples of matrix resins include thermosetting resins and thermoplastic resins. The matrix resins can be used singly, or in a combination of two or more. A matrix resin may be partly or entirely modified for the purpose of increasing its wettability to the fiber.

### (Thermosetting Resin)

The thermosetting resin is not particularly limited, and various known thermosetting resins are usable. Examples of thermosetting resins include epoxy resins, phenol resins, unsaturated polyester resins, vinyl ester resins, cyanate ester resins, and polyimide resins.

Examples of epoxy resins include bisphenol-type epoxy resins, amine-type epoxy resins, phenol novolac-type epoxy resins, cresol novolac-type epoxy resins, resorcinol-type epoxy resins, phenol aralkyl-type epoxy resins, naphthol aralkyl-type epoxy resins, dicyclopentadiene-type epoxy resins, epoxy resins with a biphenyl skeleton, isocyanate-modified epoxy resins, tetraphenylethane-type epoxy resins, and triphenylmethane-type epoxy resins.

The “bisphenol-type epoxy resins” refer to a bisphenol compound in which two phenolic hydroxyl groups are glycidylated, such as bisphenol A, bisphenol F, bisphenol AD, bisphenol S, or a halogenated form, an alkyl-substituted form, or a hydrogenated form of these bisphenols. In addition to monomers, high-molecular-weight materials with multiple repeating units can also be suitably used.

The phenol resin is, for example, a condensed reaction product of a phenol (e.g., phenol, cresol, and xylenol) and an aldehyde (e.g., formaldehyde).

Examples of unsaturated polyester resins include condensates of fumaric acid or maleic acid with ethylene oxide adduct of bisphenol A, condensates of fumaric acid or maleic acid with a propylene oxide adduct of bisphenol A, and condensates of fumaric acid or maleic acid with an ethylene oxide and propylene oxide adduct of bisphenol A (the addition of ethylene oxide and propylene oxide may be a random or block form).

Examples of vinyl ester resins include epoxy (meth)acrylate obtained by esterifying the epoxy resin described above and α,β-unsaturated monocarboxylic acid. Examples of α,β-unsaturated monocarboxylic acids include acrylic acid, methacrylic acid, crotonic acid, tiglic acid, and cinnamic acid. These can also be used in a combination of two or more.

Specific examples of vinyl ester resins include bisphenol-type epoxy resin (meth)acrylate-modified products (e.g., a (meth)acrylate-terminated resin formed by a reaction between the epoxy group of a bisphenol A-type epoxy resin and the carboxyl group of (meth)acrylic acid).

### (Thermoplastic Resins)

The matrix resin (III) is preferably a thermoplastic resin.

The thermoplastic resin is not particularly limited, and various known thermoplastic resins are usable. Examples of thermoplastic resins include polyolefin-based resins, polyamide-based resins, polyester resins, polyurethane resins, styrene-based resins, polycarbonate resins, polyacetal resins, ABS resins, phenoxy resins, polymethyl methacrylate resins, polyphenylene sulfide, polyether imide resins, and polyether ketone resins.

Examples of polyolefin-based resins include α-olefin homopolymers having about 2 to 8 carbon atoms such as ethylene, propylene, and 1-butene; and binary or ternary (co)polymers of these α-olefins with other α-olefins having about 2 to 18 carbon atoms such as ethylene, propylene, 1-butene, 3-methyl-1-butene, 1-pentene, 4-methyl-1-pentene, 4,4-dimethyl-1-pentene, 1-hexene, 4-methyl-1-hexene, 1-heptene, 1-octene, 1-decene, or 1-octadecene, or vinyl acetate. Examples of polyolefin-based resins also include acid-modified products of these polymers.

Examples of polyolefin-based resins include ethylene-based resins such as polyethylene, ethylene-propylene copolymers, ethylene-1-butene copolymers, ethylene-propylene-1-butene copolymers, ethylene-4-methyl-1-pentene copolymers, ethylene-1-hexene copolymers, ethylene-1-heptene copolymers, and ethylene-1-octene copolymers; propylene-based resins such as polypropylene, propylene-ethylene copolymers, propylene-ethylene-1-butene copolymers, propylene-ethylene-4-methyl-1-pentene copolymers, and propylene-ethylene-1-hexene copolymers; 1-butene-based resins such as 1-butene homopolymers, 1-butene-ethylene copolymers, and 1-butene-propylene copolymers; and 4-methyl-1-pentene-based resins such as 4-methyl-1-pentene homopolymers, and 4-methyl-1-pentene-ethylene copolymers.

The polyamide-based resin is not particularly limited, as long as the polyamide-based resin can form its main chain by repeating an amide linkage. Examples include polyamide 6 (by ring-opening polymerization of ε-caprolactam), polyamide 66 (by condensation polymerization of hexamethylene diamine and adipic acid), and polyamide resins formed by introducing hydrophilic groups into the main chain to make the resins water-soluble.

Examples of polyester resins include polyester resins formed by a reaction between an acid component containing polyvalent carboxylic acid with a polyhydric alcohol. Examples of polyvalent carboxylic acids include maleic acid, fumaric acid, itaconic acid, phthalic acid, trimellitic acid, isophthalic acid, terephthalic acid, tetrahydrophthalic acid, adipic acid, sebacic acid, sodium 5-sulfoisophthalate, and derivatives such as acid anhydrides thereof. These can also be used in a combination of two or more.

Examples of polyhydric alcohols include aliphatic glycols such as ethylene glycol, diethylene glycol, propylene glycol, dipropylene glycol, 1,2-propanediol, 1,2-butanediol, 1,3-butanediol, 1,4-butanediol, and neopentyl glycol; alicyclic diols such as cyclopentane diol, and cyclohexane diol; aromatic diols such as hydrogenated bisphenol A, ethylene oxide (1 mol to 100 mol) adducts of bisphenol A, propylene oxide (1 mol to 100 mol) adducts of bisphenol A, and xylene glycol; and polyhydric alcohols such as trimethylol propane, pentaerythritol, and glycerol. These can also be used in a combination of two or more.

The polyurethane resin is not particularly limited as long as the polyurethane resin is a reaction product of a polyisocyanate compound with a polyol.

Examples of styrene-based resins include resins obtained by polymerizing, in the presence or absence of a rubbery polymer, a styrene compound with one or more other compounds copolymerizable with these compounds. Examples of styrene compounds include styrene, α-methylstyrene, o-methylstyrene, p-methylstyrene, vinyl xylene, ethyl styrene, dimethylstyrene, p-tert-butylstyrene, vinyl naphthalene, methoxy styrene, monobromostyrene, dibromostyrene, fluorostyrene, and tribromostyrene.

Examples of other compounds copolymerizable with styrene compounds include vinyl cyanide compounds, acrylic acid esters, methacrylic acid esters, epoxy group-containing methacrylic acid esters, maleimide compounds, α,β-unsaturated carboxylic acid, and anhydrides thereof. Examples of rubbery polymers include polybutadiene, polyisoprene, diene copolymers, copolymers of ethylene with α-olefin, copolymers of ethylene with unsaturated carboxylic acid ester, non-conjugated diene polymers of ethylene and propylene, and acrylic rubber.

The styrene compounds, the other compounds copolymerizable with the styrene compounds, and the rubbery polymers can be used singly, or in a combination of two or more. The styrene-based resin is preferably polystyrene.

From the standpoint of excellence in physical properties and cost, the matrix resin is preferably the thermoplastic resin described above. From the same viewpoint, the matrix resin is more preferably polyolefin-based resin, polyamide-based resin, styrene-based resin, or polyphenylene sulfide, still more preferably polyethylene, polypropylene, polyamide 6, polyamide 66, polystyrene, or polyphenylene sulfide, and particularly preferably polypropylene, polyamide 6, polyamide 66, polystyrene, or polyphenylene sulfide.

Polyolefin resins often do not blend with fibers well, in particular carbon fiber and glass fiber, because of the difference of polarity. Thus, the fiber-reinforced resin obtained from a polyolefin-based resin sometimes has low mechanical strength.

Because the fiber-reinforced resin according to the present invention contains the composition for fiber-reinforced resin, a polyolefin-based resin and carbon fiber or glass fiber blend with each other well. Accordingly, the fiber-reinforced resin can have high mechanical strength.

### (Additives)

The fiber-reinforced resin may optionally contain any components (additives) other than the component (A), the fiber, and the matrix resin as long as the effect of the present invention is not impaired.

Examples of additives include flame retardants (e.g., phosphorus-containing epoxy resins or red phosphorus, phosphazene compounds, phosphates, and phosphoric esters), silicone oils, moistness dispersants, antifoaming agents, defoaming agents, natural wax, synthetic wax, metal salts of linear fatty acids, acid amide, esters, mold-releasing agents such as paraffin, crystalline silica, molten silica, calcium silicate, alumina, calcium carbonate, talc, inorganic pigments, and organic pigments.

Examples of inorganic pigments include cadmium red, cadmium lemon yellow, cadmium yellow orange, titanium dioxide, carbon black, black iron oxide, and inorganic black complex pigments.

Examples of organic pigments include aniline black, perylene black, anthraquinone black, benzidine yellow pigments, phthalocyanine blue, and phthalocyanine green.

### (Physical Properties of Fiber-Reinforced Resin)

The physical properties of the fiber-reinforced resin are not particularly limited. From the standpoint of weight reduction and mechanical strength, the fiber-reinforced resin preferably has a basis weight of about 100 g/m² to 600 g/m².

The content of the composition for fiber-reinforced resin in the fiber-reinforced resin is not particularly limited. The content of the composition for fiber-reinforced resin is, on a solids basis, preferably about 0.1 mass % to 60 mass %, and more preferably about 0.5 mass % to 60 mass % based on the total amount of the matrix resin and the fiber taken as 100 mass %. A content of the composition for fiber-reinforced resin of 0.1 mass % or more leads to greater mechanical strength of the fiber-reinforced resin. A content of the composition for fiber-reinforced resin of 60 mass % or less can suppress the reduction of impact resistance provided by the composition for fiber-reinforced resin to the matrix resin.

The content of the fiber in the fiber-reinforced resin is not particularly limited, and can be suitably selected, for example, according to the type or form of the fiber, or the type of the matrix resin. The content of the fiber is preferably 1 mass % to 70 mass %, and more preferably 3 mass % to 60 mass % based on the fiber-reinforced resin taken as 100 mass %.

The content of the matrix resin in the fiber-reinforced resin is not particularly limited, and is preferably 29 mass % to 98 mass %, and more preferably 30 mass % to 96 mass % based on the fiber-reinforced resin taken as 100 mass %.

The content of the additives in the fiber-reinforced resin is not particularly limited, and is typically 0.001 parts by mass or more, preferably 0.005 parts by mass or more, and more preferably 0.01 parts by mass or more, and typically 100 parts by mass or less, and preferably 50 parts by mass or less, per 100 parts by mass of the resin composition.

### (Method for Producing Fiber-Reinforced Resin)

The method for producing the fiber-reinforced resin according to the present invention is not particularly limited, and various known methods are usable.

The fiber-reinforced resin according to the present invention is preferably produced by the first production method, comprising

(1) the step of mixing the fiber (II) with the matrix resin (III),
(2) the step of adhering the composition for fiber-reinforced resin (I) of any one of Items 1 to 3 to a product (mixture) obtained in step (1), and,
(3) the step of heat-molding a product (adhered product) obtained in step (2).

The fiber-reinforced resin according to the present invention is preferably produced by the second production method, comprising

(1) the step of adhering the composition for fiber-reinforced resin (I) of any one of Items 1 to 3 to the fiber (II),
(2) the step of mixing a product (adhered product) obtained in step (1) with the matrix resin (III), and
(3) the step of heat-molding a product (mixture) obtained in step (2).

In step (2) of the second production method for the fiber-reinforced resin, the additives described above may optionally be mixed.

The fiber-reinforced resin according to the present invention is preferably produced by the third production method, comprising

(1) the step of mixing the composition for fiber-reinforced resin (I) of any one of Items 1 to 3, the fiber (II), and the matrix resin (III), and
(2) the step of heat-molding a product (mixture) obtained in step (1).

In step (1) of the third production method for the fiber-reinforced resin, the additives described above may optionally be mixed.

The method for adhering the composition for fiber-reinforced resin (I) to the fiber (II) is not particularly limited, and can be a processing method such as immersion, spraying, or coating.

The form of the composition for fiber-reinforced resin (I) in the adhering method above is not particularly limited. Examples include a highly viscous liquid obtained by melting the component (A), the emulsion described above, varnish obtained by dissolving the component (A) in an organic solvent, and a powder of the component (A). The method for producing the powder is not particularly limited, and can be, for example, wet powdering, dry powdering, or spray-drying powdering.

When the form of the composition for fiber-reinforced resin (I) is the emulsion or varnish, it is preferred that after the composition for fiber-reinforced resin (I) is adhered to a fiber, the composition be dried to remove water or the solvent.

In the method for producing the fiber-reinforced resin, the amount of the composition for fiber-reinforced resin (I) adhered to the fiber (II) is not particularly limited. From the standpoint of excellent mechanical strength of the fiber-reinforced resin and suppression of the coloring of the fiber-reinforced resin, the amount of the composition for fiber-reinforced resin (I) adhered to the fiber (II) is preferably 5 mass % to 120 mass %, and more preferably 10 mass % to 100 mass % based on the fiber (II) taken as 100 mass %.

The organic solvent for use in the adhering method is not particularly limited and can be suitably selected according the purpose. Examples of organic solvents include toluene, xylene, benzene, carbon tetrachloride, methylene chloride, 1,2-dichloroethane, methanol, ethanol, 1-propanol, 2-propanol, 1-butanol, methyl acetate, ethyl acetate, methyl ethyl ketone, and methyl isobutyl ketone. These solvents can be used singly, or in a combination of two or more.

The method for heat-molding is not particularly limited, and various known methods are usable. Specific examples include compounding-injection molding with chopped fibers or long fiber pellets, press molding with UD sheets, woven sheets, or non-woven sheets, filament winding molding, extrusion molding, blow molding, calendar molding, coating molding, cast molding, dipping molding, vacuum molding, and transfer molding

In press molding with a non-woven sheet, the non-woven sheet can be, for example, a non-woven fabric prepared by blending the fiber described above with a fiber of the matrix resin (blended non-woven fabric). In this case, the method for producing the fiber-reinforced resin may be press molding of the composition for fiber-reinforced resin and a non-woven sheet, optionally with additives.

The heating temperature for press molding is not particularly limited, and is preferably 230° C. to 300° C. The heating time for press molding is preferably 30 seconds or more.

The heating temperature for compounding-injection molding is not particularly limited, and is preferably 200° C. to 300° C.

In heat molding, when the matrix resin (thermoplastic resin), the fiber, and the composition for fiber-reinforced resin, optionally with additives are melt-kneaded, and when the thermoplastic resin is a resin with a high melting point such as general-purpose engineering plastics or super engineering plastics, melt-kneading is performed at the melting point or higher (200° C. to 400° C.) to produce the fiber-reinforced resin.

The technique for melt-kneading can be a known technique, and specific examples include twin-screw extruders, Henschel mixers, Banbury mixers, single-screw extruders, multi-screw extruders, and co-kneaders.

Because the fiber-reinforced resin has excellent mechanical strength, the fiber-reinforced resin can be suitably used in automotive materials such as automotive interior materials, exterior panels, or bumpers, housings for household electrical appliances, home appliance parts, packaging materials, construction materials, civil engineering materials, fishery materials, and other industrial materials, taking advantage of its characteristics.

### [Molded Article]

The molded article according to the present invention is obtained by molding the fiber-reinforced resin. The molding method is not particularly limited, and examples include injection molding, press molding, extrusion molding, blow molding, and vacuum molding. Because of its excellent mechanical strength, the molded article has the same applications as those of the fiber-reinforced resin.

### [Method of Using the Composition for Fiber-Reinforced Resin]

The composition for fiber-reinforced resin (I) according to the present invention is for use in fiber-reinforced resin.

The present invention includes the method of using the composition for fiber-reinforced resin (I) in producing fiber-reinforced resin containing the fiber (II) and the matrix resin (III).

### [Method for Reinforcing Fiber-Reinforced Resin]

The composition for fiber-reinforced resin (I) according to the present invention is for use in fiber-reinforced resin.

The present invention includes the method of reinforcing fiber-reinforced resin containing the fiber (II) and the matrix resin (III) by using the composition for fiber-reinforced resin (I).

A fiber-reinforced resin containing the fiber (II) and the matrix resin (III) is reinforced by adding (using) the composition for fiber-reinforced resin (I) according to the present invention to the fiber-reinforced resin.

A fiber-reinforced resin with sufficient mechanical strength can be obtained by combining the fiber (II) and the matrix resin (III) with the composition for fiber-reinforced resin (I) according to the present invention.

The composition for fiber-reinforced resin (I) according to the present invention can be applied to various fiber-reinforced resins, and can also be suitably used in a fiber-reinforced resin containing a thermoplastic resin as the matrix resin (III).

### EXAMPLES

The present invention is described below in more detail with reference to Examples; however, the present invention is not limited to the Examples. In the Examples, “parts” and “%” represent “parts by mass” and “mass %,” respectively.

### Production Example 1

100 parts of Chinese gum rosin and 1 part of fumaric acid were placed in a reactor equipped with a stirrer, a thermometer, a reflux condenser, a nitrogen gas inlet tube, and a water vapor inlet tube, and then the mixture was reacted at 220° C. for 2 hours in a nitrogen gas stream. Thereafter, 12.7 parts of pentaerythritol was added, and the mixture was reacted at 250° C. for 2 hours. The mixture was then further heated to 280° C., and at the same temperature, a reaction was carried out for 12 hours to complete esterification.

The pressure in the reactor was then reduced to remove water and the like to obtain a fumaric-acid-modified rosin ester (which is referred to as “component (A1)” below).

The details are shown in Table 1 (the same applies hereinafter).

### Production Example 2

50 parts of a polymerized rosin (trade name: Polymerized Rosin B-140, produced by Rosin Chemical (Wuping) Co., Ltd.), 50 parts of Chinese gum rosin, and 12 parts of pentaerythritol were placed in the same device as in Production Example 1, and then the mixture was reacted at 250° C. for 2 hours in a nitrogen gas stream. Thereafter, the mixture was further heated to 280° C., and at the same temperature, a reaction was carried out for 12 hours to complete esterification.

Water vapor of 0.1 MPa was then blown for 3 hours to obtain a polymerized rosin ester (which is referred to as “component (A2)” below).

### Production Example 3

100 parts of a C9 petroleum resin (trade name: Petrosin 120; color tone: 10 Gardner; softening point: 120° C.; produced by Mitsui Chemicals, Inc.) and 0.3 parts of a catalyst obtained by subjecting a nickel-synthetic silica-alumina catalyst oxide prepared by a precipitation method to hydrogen reduction at 400° C. for 1 hour in a hydrogen stream (nickel content: 55 wt %; catalyst surface area: 350 m²/g; bulk specific gravity: 0.30 g/cm³) were placed in a shaking autoclave, and a hydrogenation reaction was carried out under the conditions of hydrogen partial pressure: 19.6 MPa; reaction temperature: 295° C.; and reaction time: 5 hours.

After completion of the reaction, the resulting resin was dissolved in 400 parts of cyclohexane, and the catalyst was removed by filtration.

The resulting filtrate was then placed in a 1-L separable flask equipped with a stirring blade, a capacitor, a thermometer, a temperature controller, and a pressure indicator, and the solvent was removed by gradually raising the temperature to 200° C. and gradually reducing the pressure to 2.7 kPa, thereby obtaining a hydrogenated petroleum resin (which is referred to as “component (A3)” below) from the C9 petroleum resin.

### Production Example 4

1,000 parts of Chinese gum rosin was placed in a reactor equipped with a stirrer, a reflux condenser with a water separator, and a thermometer, and melted by raising the temperature to 180° C. with stirring in a nitrogen atmosphere. Subsequently, 267 parts of fumaric acid was added, and the mixture was heated to 230° C. with stirring and maintained at this temperature for 1 hour, thereby obtaining a fumaric acid-modified rosin (which is referred to as “component (A4)” below).

### Production Example 5

600.0 g of a melt of Chinese gum rosin at about 160° C. and 42 g of maleic anhydride were placed in a reactor equipped with a stirrer, a thermometer, a reflux condenser, and a nitrogen gas inlet tube, and the mixture was reacted at 200° C. for 2 hours with stirring in a nitrogen stream to obtain a maleic anhydride-modified rosin (which is referred to as “component (A5)” below).

### Production Example 6

663.2 parts of Chinese gum rosin and 55.6 parts of glycerin were placed in a reactor equipped with a stirrer, a thermometer, a reflux condenser, and a nitrogen gas inlet tube (equivalent ratio [—OH(eq)/COOH(eq)]=0.90), and further, 10 parts of Nocrac 300 (produced by Ouchi Shinko Chemical Industrial Co., Ltd.) as an antioxidant and 0.1 parts of p-toluenesulfonic acid were placed in the reactor. The mixture was reacted at 270° C. for 15 hours with stirring in a nitrogen stream to obtain a rosin ester (which is referred to as “component (A6)” below).

### Production Example 7

100 parts of a polymerized rosin (acid value: 145 mgKOH/g; softening point: 140° C.) and 14 parts of pentaerythritol were placed in a reactor equipped with a stirrer, a thermometer, a reflux condenser, a nitrogen gas inlet tube, and a water vapor inlet tube, and then the mixture was reacted at 250° C. for 2 hours in a nitrogen gas stream. Thereafter, the mixture was further heated to 280° C., and at the same temperature, a reaction was carried out for 12 hours to complete esterification.

The pressure in the reactor was then reduced to remove water and the like to obtain a polymerized rosin ester (which is referred to as “component (A7)” below).

### Production Example 8

100.0 parts of gum rosin and 100.0 parts of phenol were placed in a reactor equipped with a stirrer, a thermometer, a reflux condenser, a nitrogen gas inlet tube, and a water vapor inlet tube and then heated to 100° C., and 2.1 parts of 96% sulfuric acid was added. A reaction was carried out for 3 hours in a nitrogen gas stream. Subsequently, 3.0 parts of slaked lime was added. The mixture was then heated to 280° C. under a reduced pressure of 10 kPa, and at the same temperature, a reaction was carried out for 4 hours.

Thereafter, water and the like were removed to obtain a rosin phenol resin (which is referred to as “component (A8)” below).

### Production Example 9

500 parts of a hydroxy-containing dicyclopentadiene petroleum resin (trade name: Quintone 1700; reaction product of dicyclopentadiene and allyl alcohol; produced by Zeon Corporation; softening point: 102.0° C.; number average molecular weight: 360) and 7 parts of a nickel/diatomaceous earth catalyst (nickel loading: 50 mass %) were placed in a 1-L autoclave and maintained at 280° C., and hydrogenation was carried out at a hydrogen pressure of 20 MPa for 5 hours.

Subsequently, the resulting hydride of the hydroxy-containing dicyclopentadiene petroleum resin was taken out, dissolved in 500 parts of toluene, and the catalyst was removed by filtration. The solvent was then removed under a reduced pressure of 2.7 kPa at 200° C. for 30 minutes to obtain a hydride of the hydroxy-containing dicyclopentadiene petroleum resin (which is referred to as “component (A9)” below).

### Production Example 10

200 parts of Chinese gum rosin (WG grade; acid value: 166.1) was placed in a round-bottom flask equipped with a stirrer, a thermometer, a reflux condenser, and a nitrogen gas inlet tube and heated in a nitrogen stream to completely melt the rosin.

Thereafter, while stirring, 108.9 parts of 2,2-bis(4-hydroxyphenyl)propane diglycidyl ether was added, and 0.058 parts of 2-methylimidazole was added at 140° C. The mixture was reacted at 150° C. for 5 hours to obtain a rosin diol (which is referred to as “component (A10)” below).

### Production Example 11

200 parts of Chinese hydrogenated rosin, 3 parts of a 5% palladium alumina powder (produced by N.E. Chemcat Corporation), and 200 parts of cyclohexane were placed in a 1-L autoclave, and oxygen in the system was removed. Thereafter, the inside of the system was pressurized to 6 MPa, and then the temperature was raised to 200° C. After the temperature reached 200° C., the inside of the system was pressurized again and maintained at 9 MPa, and a hydrogenation reaction was carried out for 4 hours. The solvent was filtered off, and the cyclohexane was removed under reduced pressure, thereby obtaining 189 parts of a purified hydrogenated rosin having an acid value of 174 and a softening point of 79° C.

Subsequently, 180 parts of the resulting purified hydrogenated rosin was placed in a reactor equipped with a stirrer, a cooling tube, and a nitrogen inlet tube and melted to 200° C. Then, 21 parts of glycerin was added, and the mixture was reacted at 280° C. for 10 hours, thereby obtaining 175 parts of a rosin ester having a softening point of 90° C. and an acid value of 11.

170 parts of the resulting rosin ester, 1 part of 5% palladium carbon (water content: 50%), and 170 parts of cyclohexane were placed in a 1-L autoclave, and oxygen in the system was removed.

Thereafter, the inside of the system was pressurized to 6 MPa, and the temperature was then raised to 200° C. After the temperature reached 200° C., the inside of the system was pressurized again and maintained at 9 MPa, and a hydrogenation reaction was carried out for 4 hours. The solvent was filtered off, and the cyclohexane was removed under reduced pressure, thereby obtaining a hydrogenated rosin ester (which is referred to as “component (A11)” below).

### Production Example 12

1,000 parts of Chinese gum rosin (acid value: 170; softening point: 74° C.; color tone: 6 Gardner) and 500 parts of xylene were placed in a flask and heated for dissolution, and about 350 parts of the xylene was then distilled off.

Subsequently, 350 parts of cyclohexane was added, and the mixture was cooled to room temperature. When about 100 parts of crystals were formed by cooling, the supernatant was transferred to another flask. Further, after recrystallization at room temperature, the supernatant was removed, followed by washing with 100 parts of cyclohexane. The solvent was then distilled off to obtain 700 parts of a purified rosin.

660 parts of the resulting purified rosin and 100 parts of acrylic acid were then placed in a reactor, and the mixture was reacted at 220° C. for 4 hours with stirring in a nitrogen stream, followed by removal of unreacted material under reduced pressure, thereby obtaining 720 parts of an addition reaction product.

Further, 500 parts of the resulting addition reaction product and 5.0 parts of 5% palladium carbon (water content: 50%) were placed in a 1-L rotating autoclave, and oxygen in the system was removed.

The inside of the system was then pressurized to 10 MPa with hydrogen, and the temperature was raised to 220° C. At the same temperature, a hydrogenation reaction was carried out for 3 hours to obtain a hydride of the acrylic acid-modified rosin (which is referred to as “component (A12)” below).

### Production Example 13

23.60 parts of itaconic acid, 0.05 parts of sodium styrenesulfonate, 5.90 parts of 2-ethylhexyl acrylate, 15.30 parts of cyclohexyl methacrylate, 1.70 parts of sodium methallyl sulfonate, 53.50 parts of acrylamide, 220 parts of ion-exchanged water, 250 parts of isopropyl alcohol, and 0.50 parts of 2-mercaptoethanol as a chain transfer agent were placed in a reactor equipped with a stirrer, a thermometer, a reflux condenser, and a nitrogen gas inlet tube. The reaction system was heated to 50° C. under nitrogen gas bubbling while the mixture was stirred.

Subsequently, 2.20 parts of ammonium persulfate (APS) was added as a polymerization initiator, and the mixture was heated to 80° C. and maintained for 180 minutes.

The isopropyl alcohol was then distilled off by blowing water vapor, and a predetermined amount of ion-exchanged water was added, thereby obtaining an aqueous solution of a surfactant having a weight average molecular weight of 12,000 (solids content: 25.1%).

### Production Example 14

24 parts of sodium styrenesulfonate, 18 parts of methacrylic acid, 15 parts of acrylic acid, 11 parts of styrene, 7 parts of methyl methacrylate, and 40 parts (on a solids basis) of a polyoxyethylene phenyl ether-based reactive emulsifier (trade name: Aqualon RN-10, produced by DKS Co. Ltd.) were placed in a reactor equipped with a stirrer, a thermometer, a reflux condenser, and an nitrogen gas inlet tube, and 10 parts of ion-exchanged water was added to obtain an aqueous monomer solution.

Subsequently, 10 parts of 2,4-diphenyl-4-methyl-1-pentene, 2.4 parts of ammonium persulfate, and 72 parts of ion-exchanged water were added to the aqueous monomer solution. The reaction system was then heated to 85° C. and maintained for 2 hours, and a radical polymerization reaction was carried out. 1 part of ammonium persulfate was then added to the reaction system, and the system was kept warm for another 1 hour.

Thereafter, 18 parts of a 48% sodium hydroxide aqueous solution was added to the reaction system, and the mixture was stirred well and cooled to room temperature, thereby obtaining an aqueous surfactant solution having a solids content of 21.0%.

### Comparative Production Example 1

500 parts of Chinese gum rosin (acid value: 172; softening point: 75° C.; color tone: 6 Gardner) was placed in a 1-L flask and heated to 180° C. in a nitrogen atmosphere. While the melted rosin was stirred, 43 parts of glycerin and 33 parts of diethylene glycol were added at 200° C.

Subsequently, the mixture was heated to 270° C., and at the same temperature, an esterification reaction was carried out for 12 hours to obtain a rosin ester (which is referred to as “component (A1)′” below).

### (Softening Point)

The softening point (SP (° C.)) of each of components (A1) to (A12) and component (A1)′ was measured by the ring and ball method of JIS K 5902. Table 1 shows the results.

### (Acid Value and Hydroxyl Value)

The acid value and hydroxyl value of each of components (A1) to (A2) and (A4) to (A12), and component (A1)′ were measured according to JIS K 0070. Table 1 shows the results.

### (Color Tone)

The color tone of each of components (A3), (A9), and (A11) to (A12) was measured in Hazen unit in accordance with JIS K0071-3.

### (Measurement of Weight Average Molecular Weight (Mw))

The weight average molecular weight (Mw) of each of components (A1) to (A3) was calculated using the calibration curve of standard polystyrene by gel permeation chromatography (GPC) based on the polystyrene standards. In the GPC, the measurement was performed under the following conditions. Table 1 shows the results.

Analyzer: HLC-8320 (produced by Tosoh Corporation)

### Column: TSKgel SuperHM-L×3

Eluent: tetrahydrofuran
Concentration of sample to be injected: 5 mg/mL
Flow rate: 0.6 mL/min
Injection volume: 40 μL
Column temperature: 40° C.

### Detector: RI

### (Measurement of Weight Average Molecular Weight (Mw))

The weight average molecular weight (Mw) of each of components (A9) to (A11) was calculated using the calibration curve of standard polystyrene by gel permeation chromatography (GPC) based on the polystyrene standards. In the GPC, the measurement was performed under the following conditions. Table 1 shows the results.

Analyzer: HLC-8120 (produced by Tosoh Corporation)

### Column: TSKgel SuperHM-L×3

Eluent: tetrahydrofuran
Concentration of sample to be injected: 5 mg/mL
Flow rate: 0.6 mL/min
Injection volume: 100 μL
Column temperature: 40° C.

### Detector: RI

### (Measurement of Weight Average Molecular Weight (Mw))

The weight average molecular weight (Mw) of each of components (A4) and (A12) was calculated using the calibration curve of standard polystyrene by gel permeation chromatography (GPC) based on the polystyrene standards. In the GPC, the measurement was performed under the following conditions. Table 1 shows the results.

Analyzer: HLC-8020 (produced by Tosoh Corporation)
Column: three types of columns (TSK guard column HXL-L, TSK-GEL
G2000HXL, and TSK-GEL G1000HXL) connected
Eluent: tetrahydrofuran
Concentration of sample to be injected: 5 mg/mL
Flow rate: 0.6 mL/min
Injection volume: 100 μL
Column temperature: 40° C.

### Detector: RI

### (Measurement of Number Average Molecular Weight (Mn))

The number average molecular weight (Mn) of each of components (A3) and (A9) was calculated using the calibration curve of standard polystyrene by gel permeation chromatography (GPC) based on the polystyrene standards. In the GPC, the measurement was performed under the following conditions. Table 1 shows the results.

Analyzer: HLC-8120 (produced by Tosoh Corporation)

### Column: TSKgel SuperHM-L×3

Eluent: tetrahydrofuran
Concentration of sample to be injected: 5 mg/mL
Flow rate: 0.6 mL/min
Injection volume: 100 μL
Column temperature: 40° C.

### Detector: RI

TABLE 1

| | | | | | | Weight | Number |
|---|---|---|---|---|---|---|---|
| | | Softening | Acid | Hydroxyl | Color | average | average |
| | | point | value | value | tone | molecular | molecular |
| | (A) | (° C.) | (mgKOH/g) | (mgKOH/g) | (H) | weight | weight |
| Production | (A1) | 103 | 16 | 30 | — | 1170 | — |
| Example 1 | | | | | | | |
| Production | (A2) | 130 | 13 | 33 | — | 1410 | — |
| Example 2 | | | | | | | |
| Production | (A3) | 100 | — | — | 30 | 1300 | 750 |
| Example 3 | | | | | | | |
| Production | (A4) | 149.5 | 305 | — | — | 475 | — |
| Example 4 | | | | | | | |
| Production | (A5) | 96.5 | 233.7 | — | — | — | — |
| Example 5 | | | | | | | |
| Production | (A6) | 91 | 16 | — | — | — | — |
| Example 6 | | | | | | | |
| Production | (A7) | 160 | 10 | 40 | — | — | — |
| Example 7 | | | | | | | |
| Production | (A8) | 150 | 45 | 13 | — | — | — |
| Example 8 | | | | | | | |
| Production | (A9) | 104 | — | 100 | 150 | 500 | 400 |
| Example 9 | | | | | | | |
| Production | (A10) | 95.5 | — | 150 | — | 920 | — |
| Example 10 | | | | | | | |
| Production | (A11) | 96 | 5 | — | 20 | 820 | — |
| Example 11 | | | | | | | |
| Production | (A12) | 128.5 | 240 | — | 100 | 375 | — |
| Example 12 | | | | | | | |
| Comparative | (A1)′ | 75 | 3.7 | — | — | — | — |
| Production | | | | | | | |
| Example 1 | | | | | | | |

### [Preparation of Composition for Fiber-Reinforced Resin]

### Example 1

100 parts of component (A1) of Production Example 1 was dissolved in 70 parts of toluene at 80° C. for 3 hours. Thereafter, 3 parts (on a solids basis) of an anionic emulsifier (trade name: Neo-Hitenol F-13, produced by DKS Co. Ltd.) and 140 parts of water were added, and the mixture was stirred for 1 hour.

Subsequently, high-pressure emulsification was carried out at a pressure of 30 MPa with a high-pressure emulsifying device (produced by Manton-Gaulin) to obtain an emulsion.

Distillation under reduced pressure was then carried out for 6 hours under the conditions of 70° C. and 2.93×10⁻² MPa, thereby obtaining composition 1 for fiber-reinforced resin, having a solids content of 50%.

### Example 2

Composition 2 for fiber-reinforced resin was obtained in the same manner as in Example 1, except that component (A2) of Production Example 2 was used in place of component (A1) of Example 1.

### Example 3

Composition 3 for fiber-reinforced resin was obtained in the same manner as in Example 1, except that component (A3) of Production Example 3 was used in place of component (A1) of Example 1.

### Example 4

Component (A4) of Production Example 4 was used as is as composition 4 for fiber-reinforced resin.

### Example 5

70 parts of component (A5) of Production Example 5 and 30 parts of component (A6) of Production Example 6 were placed in a reactor equipped with a stirrer, a thermometer, a reflux condenser, and a nitrogen gas inlet tube and melted by heating at about 160° C.

Subsequently, while stirring, 7 parts (on a solids basis) of the aqueous surfactant solution of Production Example 13 was gradually added dropwise to obtain an emulsion in W/O form, and further, hot water was added to obtain a stable emulsion in O/W form.

The emulsion was then cooled to room temperature, thereby obtaining composition 5 for fiber-reinforced resin, having a solids content of 50.3%.

### Example 6

100 parts of component (A7) of Production Example 7 was dissolved in 70 parts of toluene at 80° C. for 3 hours. Thereafter, 5 parts (on a solids basis) of the aqueous surfactant solution of Production Example 14 and 140 parts of water were added, and the mixture was stirred for 1 hour.

Subsequently, high-pressure emulsification was carried out at a pressure of 30 MPa with a high-pressure emulsifying device (produced by Manton-Gaulin) to obtain an emulsion. Distillation under reduced pressure was then carried out for 6 hours under the conditions of 70° C. and 2.93×10⁻² MPa, thereby obtaining composition 6 for fiber-reinforced resin, having a solids content of 50%.

### Example 7

100 parts of component (A8) of Production Example 8 was dissolved in 70 parts of toluene at 80° C. for 3 hours. Thereafter, 5 parts (on a solids basis) of the aqueous surfactant solution of Production Example 14 and 140 parts of water were added, and the mixture was stirred for 1 hour.

Subsequently, high-pressure emulsification was carried out at a pressure of 30 MPa with a high-pressure emulsifying device (produced by Manton-Gaulin) to obtain an emulsion. Distillation under reduced pressure was then carried out for 6 hours under the conditions of 70° C. and 2.93×10⁻² MPa, thereby obtaining composition 7 for fiber-reinforced resin, having a solids content of 50%.

### Example 8

Component (A9) of Production Example 9 was used as is as composition 8 for fiber-reinforced resin.

### Example 9

Component (A10) of Production Example 10 was used as is as composition 9 for fiber-reinforced resin.

### Example 10

Component (A11) of Production Example 11 was used as is as composition 10 for fiber-reinforced resin.

### Example 11

Component (A12) of Production Example 12 was used as is as composition 11 for fiber-reinforced resin.

### Comparative Example 1

Composition 1′ for fiber-reinforced resin was obtained in the same manner as in Example 1, except that component (A1)′ of Comparative Production Example 1 was used in place of component (A1) of Example 1.

### Comparative Example 2

A commercially available aqueous dispersion of an ethylene-methacrylic acid copolymer (trade name: Chemipearl S650, produced by Mitsui Chemicals, Inc.; solids content: 27%) was used as is as composition 2′ for fiber-reinforced resin.

### [Preparation of Fiber-Reinforced Resin]

### First Production Method for Fiber-Reinforced Resin

Fiber-reinforced resins were produced by a production method comprising
(1) the step of mixing a fiber (II) with a matrix resin (III),
(2) the step of adhering a composition for fiber-reinforced resin (I) to a product (mixture) obtained in step (1), and
(3) the step of heat-molding a product (adhered product) obtained in step (2).

### Example 1-1

A carbon fiber/polypropylene blended non-woven fabric (623.7 cm²) (trade name: Carbiso TM PP/60, produced by ELG Carbon Fibre Ltd.) (step (1)) was impregnated with 100 g of composition 1 for fiber-reinforced resin adjusted to have a solids content of 5% by dilution with water (step (2)).

Thereafter, drying was performed overnight in an atmosphere of 50% RH and 23° C., followed by drying in a dryer at 105° C. for 30 minutes.

The resulting processed non-woven fabric was sandwiched between pieces of release paper and pressed at 0.5 MPa at 200° C. for 2 minutes to obtain fiber-reinforced resin 1-1 having a thickness of 1 mm (step (3)).

### Example 1-2

Fiber-reinforced resin 1-2 was obtained in the same manner as in Example 1-1, except that the solids concentration of composition 1 for fiber-reinforced resin of Example 1-1 was 10%.

### Example 1-3

Fiber-reinforced resin 1-3 was obtained in the same manner as in Example 1-1, except that composition 2 for fiber-reinforced resin was used in place of composition 1 for fiber-reinforced resin of Example 1-1, and the solids concentration thereof was 10%.

### Example 1-4

Fiber-reinforced resin 1-4 was obtained in the same manner as in Example 1-1, except that composition 3 for fiber-reinforced resin was used in place of composition 1 for fiber-reinforced resin of Example 1-1, and the solids concentration thereof was 10%.

### Example 1-5

2.53 g of composition 4 for fiber-reinforced resin was dissolved in 48.07 g of a solvent (ethanol/toluene=¼ mixed solution) to prepare 50.6 g of a solution.

Subsequently, a carbon fiber/polyamide 6 blended non-woven fabric (623.7 cm²) (trade name: PA6 TM-Sheet 300, produced by Japan Composite Materials) (step (1)) was impregnated with the solution, and drying was performed overnight in an atmosphere of 50% RH and 23° C., followed by drying in a dryer at 105° C. for 30 minutes (step (2))

The resulting processed non-woven fabric was sandwiched between pieces of release paper and pressed at 0.5 MPa at 200° C. for 2 minutes to obtain fiber-reinforced resin 1-5 having a thickness of 1 mm (step (3)).

### Comparative Example 1-1

A carbon fiber/polypropylene blended non-woven fabric (623.7 cm²) (trade name: Carbiso TM PP/60, produced by ELG Carbon Fibre Ltd.) was sandwiched between pieces of release paper and pressed at 0.5 MPa at 200° C. for 2 minutes to obtain fiber-reinforced resin 1-1′ having a thickness of 1 mm.

### Comparative Example 1-2

Fiber-reinforced resin 1-2′ was obtained in the same manner as in Example 1-1, except that composition 1′ for fiber-reinforced resin was used in place of composition 1 for fiber-reinforced resin of Example 1-1, and the solids concentration thereof was 10%.

### Comparative Example 1-3

A carbon fiber/polyamide 6 blended non-woven fabric (623.7 cm²) (trade name: PA6 TM-Sheet 300, produced by Japan Composite Materials) was sandwiched between pieces of release paper and pressed at 0.5 MPa at 200° C. for 2 minutes to obtain fiber-reinforced resin 1-3′ having a thickness of 1 mm.

### Comparative Example 1-4

A carbon fiber/polyamide 6 blended non-woven fabric (623.7 cm²) (trade name: PA6 TM-Sheet 300, produced by Japan Composite Materials) was impregnated with 100 g of composition 2′ for fiber-reinforced resin adjusted to have a solids content of 5% by dilution with water.

Thereafter, drying was performed overnight in an atmosphere of 50% RH and 23° C., followed by drying in a dryer at 105° C. for 30 minutes.

The resulting processed non-woven fabric was sandwiched between pieces of release paper and pressed at 0.5 MPa at 200° C. for 2 minutes to obtain fiber-reinforced resin 1-4′ having a thickness of 1 mm.

### (Flexural Strength Test (Flexural Strength and Flexural Modulus))

Test pieces for a flexural strength test were prepared by processing the above-mentioned fiber-reinforced resins 1-1 to 1-4′ into a size of 1 mm×25 mm×50 mm.

The flexural strength test was performed at a bending speed of 5 mm/min in accordance with JIS K 6911, and the flexural strength (MPa) and the flexural modulus (MPa) were measured. Table 2 shows the results.

TABLE 2

| | | | Physical properties of fiber- | | |
|---|---|---|---|---|---|
| Composition for fiber- | | | reinforced resin | | |
| reinforced resin | Matrix resin | Fiber | Basis | Flexural | Flexural |

| | | | Content | Blended non- | weight | strength | modulus |
|---|---|---|---|---|---|---|---|
| | (A) | (B) | (%)* | woven fabric | (g/m²) | (MPa) | (MPa) |
| Ex. 1-1 | (A1) | Neo-Hitenol F-13 | 29 | Carbiso TM PP/60 | 383 | 11.8 | 2010 |
| Ex. 1-2 | (A1) | Neo-Hitenol F-13 | 45 | Carbiso TM PP/60 | 431 | 5.1 | 539 |
| Ex. 1-3 | (A2) | Neo-Hitenol F-13 | 54 | Carbiso TM PP/60 | 459 | 11.4 | 1746 |
| Ex. 1-4 | (A3) | Neo-Hitenol F-13 | 45 | Carbiso TM PP/60 | 431 | 7.1 | 720 |
| Ex. 1-5 | (A4) | — | 12 | PA6 TM-Sheet 300 | 380 | 102.1 | 7923 |
| Comp. | — | | 0 | Carbiso TM PP/60 | 298 | 1.7 | 193 |
| Ex. 1-1 | | | | | | | |
| Comp. | (A1)′ | Neo-Hitenol F-13 | 30 | Carbiso TM PP/60 | 388 | 2.3 | 230 |
| Ex. 1-2 | | | | | | | |

| | | | | | | |
|---|---|---|---|---|---|---|
| Comp. | — | 0 | PA6 TM-Sheet 300 | 338 | 44.3 | 3976 |
| Ex. 1-3 | | | | | | |
| Comp. | Chemipearl S650 | 12 | PA6 TM-Sheet 300 | 381 | 45.3 | 3695 |
| Ex. 1-4 | | | | | | |

The abbreviations and note in Table 2 are as follows.
*Content (solids content) of the composition for fiber-reinforced resin based on the blended non-woven fabric taken as 100 mass %

### (Abbreviations and Details of Compounds)

Neo-Hitenol F-13: an anionic emulsifier produced by DKS Co. Ltd.
Carbiso TM PP/60: a carbon fiber/polypropylene blended non-woven fabric produced by ELG Carbon Fibre Ltd.
PA6 TM-Sheet 300: a carbon fiber/polyamide 6 blended non-woven fabric produced by Japan Composite Materials
Chemipearl S650: an aqueous dispersion of an ethylene-methacrylic acid copolymer produced by Mitsui Chemicals, Inc.

### [Preparation of Fiber-Reinforced Resin]

### Second Production Method for Fiber-Reinforced Resin

Fiber-reinforced resins were produced by a production method comprising
(1) the step of adhering a composition for fiber-reinforced resin (I) to a fiber (II);
(2) the step of mixing a product (adhered product) obtained in step (1) with a matrix resin (III), and
(3) the step of heat-molding a product (mixture) obtained in step (2).

### Example 2-1

A carbon fiber woven fabric (400 cm²) (trade name: Torayca Cloth CO6343; plain fabric; thickness: 0.25 mm; 198 g/m²; produced by Toray Industries, Inc.) was impregnated with 15.8 g of composition 1 for fiber-reinforced resin adjusted to have a solids content of 5% by dilution with water, and drying was performed overnight in an atmosphere of 50% RH and 23° C., followed by drying in a dryer at 105° C. for 30 minutes (step (1)).

The resulting processed carbon fiber woven fabric was sandwiched between polypropylene (PP) sheets (400 cm²) (trade name: PP Craft Film; thickness: 0.2 mm; 184 g/m²; produced by Acrysunday Co., Ltd.) so that a stack of PP/carbon fiber/PP/carbon fiber/PP was obtained (step (2)).

Further, the resulting product was sandwiched between pieces of release paper and pressed at 0.5 MPa at 200° C. for 2 minutes to obtain fiber-reinforced resin 2-1 having a thickness of 1.3 mm (step (3)).

### Example 2-2

A carbon fiber woven fabric (400 cm²) (trade name: Torayca Cloth CO6343; plain fabric; thickness: 0.25 mm; 198 g/m²; produced by Toray Industries, Inc.) was impregnated with 15.8 g of composition 1 for fiber-reinforced resin adjusted to have a solids content of 5% by dilution with water, and drying was performed overnight in an atmosphere of 50% RH and 23° C., followed by drying in a dryer at 105° C. for 30 minutes (step (1)).

The resulting processed carbon fiber woven fabric was sandwiched between polyphenylene sulfide (PPS) sheets (400 cm²) (trade name: PPS Film; thickness: 0.1 mm; 90 g/m²; produced by As One Corporation) so that a stack of PPS/carbon fiber/PPS/carbon fiber/PPS was obtained (step (2)).

Further, the resulting product was sandwiched between pieces of release paper and pressed at 0.5 MPa at 300° C. for 5 minutes to obtain fiber-reinforced resin 2-2 having a thickness of 0.7 mm (step (3)).

### Example 2-3

Fiber-reinforced resin 2-3 was obtained in the same manner as in Example 2-2, except that composition 5 for fiber-reinforced resin was used in place of composition 1 for fiber-reinforced resin of Example 2-2.

### Example 2-4

Fiber-reinforced resin 2-4 was obtained in the same manner as in Example 2-2, except that composition 6 for fiber-reinforced resin was used in place of composition 1 for fiber-reinforced resin of Example 2-2.

### Example 2-5

Fiber-reinforced resin 2-5 was obtained in the same manner as in Example 2-2, except that composition 7 for fiber-reinforced resin was used in place of composition 1 for fiber-reinforced resin of Example 2-2.

### Example 2-6

A glass fiber woven fabric (400 cm²) (trade name: Glass Mat; 450 g/m²; produced by Sunday Paint Co., Ltd.) was impregnated with 38.8 g of composition 6 for fiber-reinforced resin adjusted to have a solids content of 5% by dilution with water. Thereafter, drying was performed overnight in an atmosphere of 50% RH and 23° C., followed by drying in a dryer at 105° C. for 30 minutes (step (1)).

The resulting processed glass fiber woven fabric was sandwiched between polyamide 66 (PA66) sheets (400 cm²) (trade name: 66 Nylon Sheet; thickness: 0.3 mm; 372 g/m²; produced by Kokugo Co., Ltd.) so that a stack of PA66/glass fiber/PA66 was obtained (step (2)).

Further, the resulting product was sandwiched between pieces of release paper and pressed at 0.5 MPa at 300° C. for 5 minutes to obtain fiber-reinforced resin 2-6 having a thickness of 0.7 mm (step (3)).

### Example 2-7

Fiber-reinforced resin 2-7 was obtained in the same manner as in Example 2-6, except that composition 5 for fiber-reinforced resin was used in place of composition 6 for fiber-reinforced resin of Example 2-6.

### Comparative Example 2-1

A carbon fiber woven fabric (400 cm²) (trade name: Torayca Cloth CO6343; plain fabric; thickness: 0.25 mm; 198 g/m²; produced by Toray Industries, Inc.) was sandwiched between polypropylene (PP) sheets (400 cm²) (trade name: PP Craft Film; thickness: 0.2 mm; 184 g/m²; produced by Acrysunday Co., Ltd.) so that a stack of PP/carbon fiber/PP/carbon fiber/PP was obtained.

Further, the resulting product was sandwiched between pieces of release paper and pressed at 0.5 MPa at 200° C. for 2 minutes to obtain fiber-reinforced resin 2-1′ having a thickness of 1.3 mm.

### Comparative Example 2-2

A carbon fiber woven fabric (400 cm²) (trade name: Torayca Cloth CO6343; plain fabric; thickness: 0.25 mm; 198 g/m²; produced by Toray Industries, Inc.) was sandwiched between polyphenylene sulfide (PPS) sheets (400 cm²) (trade name: PPS Film; thickness: 0.1 mm; 90 g/m²; produced by As One Corporation) so that a stack of PPS/carbon fiber/PPS/carbon fiber/PPS was obtained.

Further, the resulting product was sandwiched between pieces of release paper and pressed at 0.5 MPa at 300° C. for 5 minutes to obtain fiber-reinforced resin 2-2′ having a thickness of 0.7 mm.

### Comparative Example 2-3

A glass fiber woven fabric (400 cm²) (trade name: Glass Mat; 450 g/m²; produced by Sunday Paint Co., Ltd.) was sandwiched between polyamide 66 (PA66) sheets (400 cm²) (trade name: 66 Nylon Sheet; thickness: 0.3 mm; 372 g/m²; produced by Kokugo Co., Ltd.) so that a stack of PA66/glass fiber/PA66 was obtained.

Further, the resulting product was sandwiched between pieces of release paper and pressed at 0.5 MPa at 300° C. for 5 minutes to obtain fiber-reinforced resin 2-3′ having a thickness of 0.7 mm.

### (Flexural Strength Test (Flexural Strength and Flexural Modulus))

Test pieces for a flexural strength test were prepared by processing the above-mentioned fiber-reinforced resins 2-1 to 2-3′ into a size of 1 mm×25 mm×50 mm.

The flexural strength test was performed at a bending speed of 5 mm/min in accordance with JIS K 6911, and the flexural strength (MPa) and the flexural modulus (MPa) were measured. Table 3 shows the results.

TABLE 3

| | Composition for fiber- | | | | | Physical properties of | | |
|---|---|---|---|---|---|---|---|---|
| | reinforced resin | | | | | fiber-reinforced resin | | |
| | | | Amount | | | Basis | Flexural | Flexural |
| | | | adhered | | | weight | strength | modulus |
| | (A) | (B) | (%)* | Matrix resin | Fiber | (g/m²) | (MPa) | (MPa) |
| Ex. 2-1 | (A1) | Neo-Hitenol | 10 | Polypropylene | Carbon | 218 | 72.9 | 5995 |
| | | F-13 | | | fiber | | | |
| Ex. 2-2 | (A1) | Neo-Hitenol | 10 | Polyphenylene sulfide | Carbon | 218 | 77.6 | 4732 |
| | | F-13 | | | fiber | | | |
| Ex. 2-3 | (A5) | Production | 10 | Polyphenylene sulfide | Carbon | 218 | 75.1 | 4605 |
| | (A6) | Example 13 | | | fiber | | | |
| Ex. 2-4 | (A7) | Production | 10 | Polyphenylene sulfide | Carbon | 218 | 77.3 | 5456 |
| | | Example 14 | | | fiber | | | |
| Ex. 2-5 | (A8) | Production | 10 | Polyphenylene sulfide | Carbon | 218 | 77.9 | 7434 |
| | | Example 14 | | | fiber | | | |
| Ex. 2-6 | (A7) | Production | 10 | Polyamide 66 | Glass fiber | 534 | 72.6 | 14524 |
| | | Example 14 | | | | | | |
| Ex. 2-7 | (A5) | Production | 10 | Polyamide 66 | Glass fiber | 534 | 73.2 | 20399 |
| | (A6) | Example 13 | | | | | | |

| | | | | | | | |
|---|---|---|---|---|---|---|---|
| Comp. | — | 0 | Polypropylene | Carbon | 198 | 43.5 | 2334 |
| Ex. 2-1 | | | | fiber | | | |
| Comp. | — | 0 | Polyphenylene sulfide | Carbon | 198 | 55.2 | 2139 |
| Ex. 2-2 | | | | fiber | | | |
| Comp. | — | 0 | Polyamide 66 | Glass fiber | 485 | 55.1 | 10729 |
| Ex. 2-3 | | | | | | | |

The abbreviations and note in Table 3 are as follows.
*Amount (solids content) of the composition for fiber-reinforced resin adhered based on the fiber taken as 100 mass %

### (Abbreviations and Details of Compounds)

Neo-Hitenol F-13: an anionic emulsifier produced by DKS Co. Ltd.
Polypropylene: trade name “PP Craft Film” (thickness: 0.2 mm; 184 g/m²; produced by Acrysunday Co., Ltd.)
Polyphenylene sulfide: trade name “PPS Film” (thickness: 0.1 mm; 90 g/m²; produced by As One Corporation)
Polyamide 66: trade name “66 Nylon Sheet” (thickness: 0.3 mm; 372 g/m²; produced by Kokugo Co., Ltd.)
Carbon fiber: trade name “Torayca Cloth CO6343” (plain fabric;
thickness: 0.25 mm; 198 g/m²; produced by Toray Industries, Inc.)
Glass fiber: trade name “Glass Mat” (450 g/m²; produced by Sunday Paint Co., Ltd.)

### [Preparation of Fiber-Reinforced Resin]

### Third Production Method for Fiber-Reinforced Resin

Fiber-reinforced resins were produced by a production method comprising
(1) the step of mixing the composition for fiber-reinforced resin (I) of any one of Items 1 to 3, a fiber (II), and a matrix resin (III), and
(2) the step of heat-molding a product (mixture) obtained in step (1).

### Example 3-1

69 parts of polypropylene (trade name: Novatec-PP BC2E, produced by Japan Polypropylene Corporation), 1 part of composition 8 for fiber-reinforced resin, and 30 parts of glass fiber chopped strands (Chopped Strand 3 mm, produced by Featherfield) were placed in a 100-mL separable flask (step (1)), and the mixture was heated at 230° C. and then kneaded with a stirring blade for 20 minutes (step (2)).

The resulting product was then taken out to an aluminum vat to obtain fiber-reinforced resin 3-1.

### Example 3-2

Fiber-reinforced resin 3-2 was obtained in the same manner as in Example 3-1, except that 96 parts of polystyrene (trade name: PSJ-Polystyrene HF77, produced by PS Japan Corporation) was used in place of polypropylene of Example 3-1, and glass fiber chopped strands (Chopped Strand 3 mm, produced by Featherfield) was used in an amount of 3 parts.

### Example 3-3

Fiber-reinforced resin 3-3 was obtained in the same manner as in Example 3-1, except that composition 9 for fiber-reinforced resin was used in place of composition 8 for fiber-reinforced resin of Example 3-1.

### Example 3-4

Fiber-reinforced resin 3-4 was obtained in the same manner as in Example 3-1, except that composition 10 for fiber-reinforced resin was used in place of composition 8 for fiber-reinforced resin of Example 3-1.

### Example 3-5

Fiber-reinforced resin 3-5 was obtained in the same manner as in Example 3-1, except that composition 11 for fiber-reinforced resin was used in place of composition 8 for fiber-reinforced resin of Example 3-1.

### Example 3-6

Fiber-reinforced resin 3-6 was obtained in the same manner as in Example 3-1, except that composition 4 for fiber-reinforced resin was used in place of composition 8 for fiber-reinforced resin of Example 3-1.

### Comparative Example 3-1

Fiber-reinforced resin 3-1′ was obtained in the same manner as in Example 3-1, except that polypropylene of Example 3-1 was used in an amount of 70 parts, and composition 8 for fiber-reinforced resin was not used.

### Comparative Example 3-2

Fiber-reinforced resin 3-2′ was obtained in the same manner as in Example 3-2, except that polystyrene of Example 3-2 was used in an amount of 97 parts, and composition 8 for fiber-reinforced resin was not used.

### [Preparation of Fiber-Reinforced Resin Sheet]

Each of fiber-reinforced resins 3-1 to 3-2′ obtained above was placed in a 100 mm×100 mm×0.25 mm mold and press-molded at 200° C. when the matrix resin was polypropylene and at 230° C. when the matrix resin was polystyrene, thereby obtaining fiber-reinforced resin sheets each having a thickness of 0.25 mm.

### (Three-Point Bending Test (Flexural Strength and Flexural Deflection))

The fiber-reinforced resin sheets obtained above were cut into 15 mm×5 mm strips to obtain test pieces. These test pieces were subjected to a three-point bending test using Thermomechanical Analyzer TMA-60 (produced by Shimadzu Corporation), and the flexural strength (N) and the flexural deflection to break (mm) were measured. Table 4 shows the results.

The higher the flexural strength and flexural deflection values, the higher the mechanical strength in the fiber-reinforced resin.

### (Evaluation of Dispersibility)

The fiber-reinforced resin sheets obtained above were visually checked. When a fiber bundle or fuzzing was observed, it was evaluated as “x,” and when no fiber bundle or fuzzing was observed, it was evaluated as “o.” Table 4 shows the results.

The better the dispersibility, the more excellent the design and low-dielectric properties of the fiber-reinforced resin.

TABLE 4

| | | | | | | | | | Physical properties of fiber- | | |
|---|---|---|---|---|---|---|---|---|---|---|---|
| | | | | | | | | | reinforced resin | | |
| | Composition for fiber- | | | | | | | Fiber | | Flexural | Flexural |
| | reinforced resin | | | | | Matrix resin | | Glass | | strength | deflection |
| | (A9) | (A10) | (A11) | (A12) | (A4) | Polypropylene | Polystyrene | fiber | Dispersibility | (N) | (mm) |
| Ex. 3-1 | 1 | — | — | — | — | 69 | — | 30 | ∘ | 1.0 | 1.8 |
| Ex. 3-2 | 1 | — | — | — | — | — | 96 | 3 | ∘ | 0.9 | 1.9 |
| Ex. 3-3 | — | 1 | — | — | — | 69 | — | 30 | ∘ | 1.1 | 1.8 |
| Ex. 3-4 | — | — | 1 | — | — | 69 | — | 30 | ∘ | 1.1 | 1.8 |
| Ex. 3-5 | — | — | — | 1 | — | 69 | — | 30 | ∘ | 1.1 | 1.8 |
| Ex. 3-6 | — | — | — | — | 1 | 69 | — | 30 | ∘ | 1.1 | 1.8 |
| Comp. | — | — | — | — | — | 70 | — | 30 | x | 0.8 | 1.4 |
| Ex. 3-1 | | | | | | | | | | | |
| Comp. | — | — | — | — | — | — | 97 | 3 | x | 0.6 | 1.5 |
| Ex. 3-2 | | | | | | | | | | | |

The amounts in Table 4 are part by mass values. The abbreviations in Table 4 are as follows.

### (Abbreviations and Details of Compounds)

Polypropylene: trade name “Novatec-PP BC2E” produced by Japan Polypropylene Corporation
Polystyrene: trade name “PSJ-Polystyrene HF77” produced by PS Japan Corporation
Glass fiber: trade name “Chopped Strand 3 mm” produced by Featherfield

1. A composition for fiber-reinforced resin (I) comprising a resin (A), wherein the resin (A) is at least one resin selected from the group consisting of rosin resins, petroleum resins, terpene resins, and hydrides of cyclic ketone-aldehyde resins, and the resin (A) has a softening point of 80° C. to 180° C.

2. The composition for fiber-reinforced resin (I) according to claim 1, wherein the resin (A) is at least one member selected from the group consisting of α,β-unsaturated carboxylic-acid-modified rosins, rosin esters, rosin phenol resins, rosin diols, and petroleum resins.

3. The composition for fiber-reinforced resin (I) according to claim 1, further comprising a surfactant (B), the composition for fiber-reinforced resin (I) being an emulsion comprising the resin (A) and the surfactant (B).

4. A fiber-reinforced resin comprising
the composition for fiber-reinforced resin (I) of claim 1,
a fiber (II), and
a matrix resin (III).

5. The fiber-reinforced resin according to claim 4, wherein the fiber (II) is at least one fiber selected from the group consisting of carbon fiber and glass fiber.

6. The fiber-reinforced resin according to claim 4, wherein the matrix resin (III) is a thermoplastic resin.

7. A method for using the composition for fiber-reinforced resin (I) of claim 1 in producing a fiber-reinforced resin containing a fiber (II), and a matrix resin (III).

8. A method for reinforcing a fiber-reinforced resin containing a fiber (II), and a matrix resin (III) by using the composition for fiber-reinforced resin (I) of claim 1.

9. A method for producing the fiber-reinforced resin of claim 4, the method comprising
(1) a step of mixing the fiber (II) with the matrix resin (III),
(2) a step of adhering the composition for fiber-reinforced resin (I) to a product obtained in the step (1), and
(3) a step of heat-molding a product obtained in the step (2).

10. A method for producing the fiber-reinforced resin of claim 4, the method comprising
(1) a step of adhering the composition for fiber-reinforced resin (I) to the fiber (II),
(2) a step of mixing a product obtained in the step (1) with the matrix resin (III), and,
(3) a step of heat-molding a product obtained in the step (2).

11. A method for producing the fiber-reinforced resin of claim 4, the method comprising
(1) a step of mixing the composition for fiber-reinforced resin (I), the fiber (II), and the matrix resin (III), and
(2) a step of heat-molding a product obtained in the step (1).

12. A molded article obtained by molding the fiber-reinforced resin of claim 4.
